(19) United States
(12) Patent Application Publication
(10) Pub. No.: US 2007/0256105 A1
(43) Pub. Date: Nov. 1, 2007

(54) Entertainment device configured for interactive detection and security vigilant monitoring in communication with a control server

(76) Inventor: Joseph Akwo Tabe, Silver Spring, MD (US)

Correspondence Address: Joseph A. Tabe;Tajintech Corporation, Suite 717, 11700 Old Columbia pike, Silver spring, MD, 20904, US

(21) Appl. No.: 11/634,535

(22) Filed: Dec. 5, 2006

Related U.S. Application Data
(60) Provisional application No. 60/721,103, filed on Dec. 8, 2005.

(51) Int. Cl. H04N 7/18

(52) U.S. Cl. 725/78

(57) ABSTRACT

Home security detectors configured with the control components of the home comprising interactive detectors enhanced to support location-awareness and home occupant-awareness and functionality. The system includes at least one motion sensor configured with communication devices operatively arranged to transmit information about any motion of occupants in the various sections of the home as part of the information about the occupancy of the home during an emergency. At least one sensor is provided in various rooms of a home each sensing a state of the home. A central communication device is coupled, wired or wirelessly, directly or indirectly, to each home sensor configured to transmit the state of the home. The number of occupants in the home are determined by at least one body heat sensor and at least one heartbeat sensor each configured with the interactive detectors to detect the presence of emergency and home occupants and to know the present situations such as their heartbeats, such that the number of occupants and their locations are determinable from the number of detected body heat and their security and safety conditions are determinable by their heartbeats. The detection method includes the steps of sensing a state of the home and transmitting the state of the home to at least a server. Images of the home are captured by at least a camera means configured with at least a MOS and/or CMOS based active sensor array for producing real-time images and stored in the server for wireless retrieval. The images ideally include at least an intruder of the home. The server is configured with a central processor for enabling controlling security vigilance monitoring and for enabling rapid distribution of detection data, voice, and other detection signals within the monitoring environment. The system establishes a network which includes configuring home audio/visual devices, media destination means such as televisions, monitors, PDAs, notepads, notebooks, MP3, wireless stereo, cell phones etc for the detection means. The control server supports video/audio servings, telephony, messaging, file sharing, internetworking, and security monitoring and allows home occupants to access and control the home network environment from any location within a controlled residential, commercial/industrial and/or non-residential, commercial/industrial environment with at least a computer means such as a cell phone.

The present invention relates generally to Interactive television configured with embedded camera for enabling security vigilant monitoring and networking, and more specifically, for distributing detected information within a network through a control server. The present invention is further related to the methods and apparatus for sensing and determining the status of a home and the home occupancy security prior to, during and/or after an emergency-condition or environment of an unsafe situation and transmitting data relating to the home-owner's safety from the home to at least a remote facility such as an emergency response station or a cell phone.

The present invention also relates to methods and apparatus for detecting sections of a home and transmitting data relating to the detection of occupants in the sections of the home and providing other information relating to the safety and safe-living conditions to the home owner or at least a response station.

### BACKGROUND OF THE INVENTION

The innovation of the information age has revealed new and exciting opportunities for interactive high definition television capabilities. Personal televisions have been deployed in a variety of arenas to gain image clarity and efficiencies, reduce cost, and increase productivity. Miniaturization and portability have made personal televisions more accessible and a more valued tool in many business environments. Personal televisions have also become a very useful tool in non-business environments, including educational institutions and homes.

Home television network in connection with a computer means are gaining increased popularity. Within a home, multiple personal televisions can be connected together in the home and/or used for office computer to permit a home occupant to share security data and other data without having to manually carry a camera from one room to another. The television network in connection with a computer means also permits the home occupant to receive detected data, share printers, fax machines, and other devices or reach other distant destination. Internet access facilities can also be provided to permit access to external networks and services. Thus, a home occupant can operate an interactive high definition television through his cell phone in communication with a control server to gain instant access to information source from anywhere in the world.

Despite the increasing presence of home television network in connection with a computer means, several significant problems must be overcome. For example, installing a home detection network can be time extensive and expensive to deploy. Additionally, there is no easy method to integrate home television network in connection with a computer means with other residential, commercial/industrial devices, destination, such as televisions, stereos, cell phones, DVD distributors, and other home electronics. Being able to efficiently distribute digital audio/video (AV) data among personal televisions and other AV devices, destination such as, televisions, DVD distributors, PVRs, etc. is complicated by differing and evolving detection and communications standards and/or formats.

Another significant challenge is being able to effectively control the networked residential, commercial/industrial devices, destination. Although a remote control unit can be trained to send signals to components of an entertainment center such as, a television, stereo, and VCR, there is no known central device that can communicate and control multiple personal televisions and other analog and/or digital devices, destination at offices and residence or office environment.

Although the combination of improved interactive high definition television capabilities and global access to detection information has resulted in significant advancements in the information processing age, there exists a need for a simple, inexpensive, yet versatile system that can integrate the functions of interactive high definition television into multiple security and detection device for residential, commercial/industrial/office and connected to a residential, commercial/industrial/office network and access-able from any remote location to enable home protection from physical theft, un-authorized entry, burglary, etc.

### SUMMARY OF THE INVENTION

The present invention provides a method, system and programmed interactive high definition television product for security monitoring and for managing a plurality of devices, destination and/or applications within an environment, such as a home, business, school, etc, as well as its surrounding areas. A control server comprises one or more servers or processing systems, and enables centralized command and control of the devices, destination and/or applications.

In one embodiments of the present invention, the devices, destination means and/or applications include entertainment and communication equipment such as, television, telephone, intercoms, etc. The present invention further includes entertainment systems such as, televisions, CD/DVD distributors, computer applications, stereos, etc. The devices and entertainment system are coupled to a monitoring system such as, computers, security cameras, and baby monitor with/without cameras, etc. to enable a security system. The security systems further include devices such as, body heat sensors, fire alarms, burglary alarm, glass alarm, sprinkler systems, door lock or window sensors, and personal computer such as, servers, desktops, notebooks, notepads, personal digital assistants, cell phones, wireless devices or the like.

In other embodiments of the present invention, the control server distributes information including video, audio, voice, text, graphics, control messages, detection data etc. to coded addresses and/or other applications. The control server supports video/audio serving, telephony, messaging, file sharing, internetworking, and/or security monitoring.

Yet in other embodiments of the present invention, a detection platform that is small in physical size, has access to power lines for continuous and uninterrupted electrical power, and is physically located within the body of a television to facilitate transmission and reception of wireless signals is suitable for housing or hosting the interactive hardware comprising the control server. In an instant embodiment, a smoke detector serves as a detection platform for the control server. The smoke detector's ceiling-wall mounted base and direct connection to a home or office's existing voltage AC power line provides an ideal platform for the control server and enables information to be transported throughout the controlled environment either through a wireless connection or through the power line. The control server can be housed within a wired/wireless access point, which provides the control server with “always-on” and wired/wireless connectivity.

Still in other embodiments of the present invention, a wireless controller such as a digital personal assistant, cell phone, wireless notepad, etc. enable a home occupant to interact with the control server. Such interaction includes altering the configuration and performance of the other devices, destination and/or applications. Accordingly, the wireless controller provides remote access to other devices, destination and/or applications, and enables the home occupant to control other functions and/or operations from any location within the environment. In one embodiment, the control server is located within the wireless controller. In another embodiment, the control server is located at a centralized location that is distinct from the wireless controller.

In other embodiments of the present invention, the wireless controllers are equipped with location-awareness and/or home occupant-awareness functionality. As such, the control server in communication with a television has the ability to track and/or monitor the position of the wireless controllers and enable personalized configurations and data transmission based on the home occupant identity.

In yet another embodiment, one or more control microprocessor 105 for enabling communication can be established, either automatically by the control server and the home occupant, to control the operations, detections, and/or functions of the interactive high definition television system components. A control microprocessor 105s includes a set of commands that, when executed, enables the control server to manage multiple operations and/or functions of one or more of the television system and other components. The control microprocessor 105s can be associated with a control microprocessor 105s detection data for future recall and execution. The control microprocessors 105 are stored at the control server. In an embodiment, the wireless controller is programmable to issue a generic control request to the control server to thereby execute the sequence of commands from the control microprocessor 105.

It is still an object of the present invention to provide a new and improved method and system for obtaining information about the security and occupancy state of a home and conveying this information to remotely situated assistance personnel.

It is another object of the present invention to provide a new and improved method and system for obtaining information about the security and occupancy state of a home and conveying this information to remotely situated assistance personnel or assistance hand held/computer devices such as a cell phone to optimize responses to at least an instance of an emergency, including at least a break-through involving the home and/or enable proper assistance to be rendered to the home occupants after the break-through has occurred.

It is another object of the present invention to provide a new and improved method and system for determining the presence of an object on a particular location of a common home and conveying this information over a wired/wireless data link system or cellular phone.

It is another object of the present invention to provide a new and improved method and system for determining the presence of an object on a particular section of a common home and using this information to activate the operation of interactive wireless home security detectors and enabling communication with at least a data link system or a wired/wireless network and/or cellular phone.

It is still another object of the present invention to provide a new and improved method and system for determining the presence of, and the total number of occupants in various sections of a home, and, in the event of an emergency-condition, transmitting that information, as well as other information such as the condition of the occupants, to a receiver site remote from the home.

It is yet another object of the present invention to provide a new and improved occupant sensory system and/or a detection platform which determines the presence and health state of any occupants in the home by analyzing sounds emanating from the various sections and directing such sounds to a remote facility or a manned site for consideration in dispatching response personnel or respondent.

Still another object of the present invention is to provide a new and improved home monitoring system which provides a communication channel between the home “Central communication device” and a manned assistance facility to enable communication with the central communication device and the home occupants after a break-through, or whenever the occupants are in need of assistance particularly during an emergency or when the communication is initiated from the remote facility in response to a condition at the home that the operator of the remote facility may not know exists

It is yet another object of the present invention to provide a new and improved method and system for diagnosing sections of a home and the safe-living status of the home and alerting the home's security-agencies, or another repair facility, via a teleconferencing link that a component of the home is functioning abnormally and may be in danger of failing.

It is still another object of the present invention to provide a new and improved method and apparatus for obtaining information about a home system and sections in the home in conjunction with failure of any of the components of the home and sending this information to the remote facility.

Accordingly, to achieve at least one of these objects, a home comprises an occupant sensing system for determining at least one fire-property or characteristic of occupancy state of the home constituting information about the occupancy of the home and enabling communication devices coupled to the occupant sensing system arranged to transmit the information about the occupancy state of the home. The communication devices may comprise a hidden interactive reporter, a cellular telephone system including an antenna or other similar communication-enabling devices.

The occupant sensing system may include plurality of the same or different sensors; for example, an image-obtaining sensor for obtaining images of the various sections of the home whereby the communication devices transmits the images. If a break-through sensor is provided for determining when the home experiences a break-through, the image-obtaining sensor may be designed to obtain images including the intruder of the home with the communication devices being coupled to the break-through sensor and arranged to transmit images of the various sections just prior to the break-through once the break-through sensor has determined that the home has experienced a break-through, during the break-through once the break-through sensor has determined that the home has experienced a break-through and/or after the break-through once the break-through sensor has determined that the home has experienced a break-through.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the leftmost digit(s) of a reference number identifies the drawing in which the reference number first appears.

FIG. 1 illustrates a control system according to an embodiment of the present invention.

FIG. 2 illustrates a control server with archival and/or retrieval components according to an embodiment of the present invention.

FIG. 3 illustrates a control server according to an embodiment of the present invention.

FIG. 4A illustrates a positioning mechanism for a control system according to an embodiment of the present invention.

FIG. 4B illustrates a positioning mechanism for a control system according to another embodiment of the present invention

FIG. 5 illustrates a flow diagram for tracking and/or monitoring system components according to an embodiment of the present invention.

FIG. 6 illustrates a flow diagram for commanding and/or controlling system components in response to home occupant location according to an embodiment of the present invention.

FIG. 7 illustrates home occupant interface for presenting control options according to an embodiment of the present invention.

FIG. 8 is an example computer system useful for implementing the present invention.

FIG. 9 illustrates a flow diagram for defining control microprocessor 105s to watch a movie recording according to an embodiment of the present invention.

FIG. 10 illustrates a flow diagram for activating the control microprocessor 105s of FIG. 9 according to an embodiment of the present invention.

FIG. 11 illustrates a control system according to another embodiment of the present invention.

FIG. 12 illustrates a control system according to another embodiment of the present invention.

FIG. 13 illustrates a control system according to another embodiment of the present invention.

### DETAILED DESCRIUPTION OF THE INVENTION

The present invention is directed towards the centralized high definition interactive television configured with a camera and a server to enable security and monitoring command and control of a plurality of devices, destination and/or applications within a controlled environment, such as at least a home, a business, a school, etc. Therefore in many embodiments of the present invention, the controlled environment is a residential, commercial/industrial environment. The residential, commercial/industrial environment pertains to the confines of homes, industries, companies, apartments, mobile home, houseboat, or other types of offices and residences. In one embodiment, the residential, commercial/industrial environment includes the surrounding area of the homes, the industries, the company offices and residences, as well as any shelters, constructs, improvements, or the like, within a designated perimeter of the environment.

In other embodiments, the present invention is implemented in non-residential, commercial/industrial environments. A non-residential, commercial/industrial environment includes, but is not limited to, an office complex, suite of small offices, production studio, warehouse, entertainment arena, health care facility, hotel, vacation resort, aircraft, ship, automobile, or the like. In these and other embodiments, the controlled environment for the non-residential, commercial/industrial embodiments includes not only the actual confines of the aforementioned structures but also other surroundings within a designated perimeter.

Within the controlled environment of the present invention comprises an entertainment device such as a television configured with a camera and one or more controlled servers, or the like to provide a centralized command and control for distributing information, including video, audio, voice, text, graphics, control messages, etc. to the other devices, destination and/or applications, including a cell phone. The devices and destination means and/or applications include entertainment and communication equipment such as, telephones, intercoms, etc. in communication with the entertainment systems such as, televisions, CD/DVD distributors, computer system/applications, stereos, etc. to enable security monitoring. The monitoring system further include security cameras, baby monitor with/without cameras and the like in communication with the safety/security systems such as, body heat sensors, fire alarms, burglary alarm, glass alarm, sprinkler systems, door lock or window sensors, personal televisions, desktops, notebooks, notepads, personal digital assistants, or the like.

In another embodiment, a wireless device such as a digital personal assistant, cell phone, wireless control module, wireless notepad, etc. enables a home occupant to interact with the centralized command and control server. Such interaction includes checking and altering the configuration and performance of the other devices, destination and/or applications within the controlled environment. Accordingly, the wireless device provides remote access to other devices, destination and/or applications, and enables the home occupant to control other functions and/or operations from any location within the controlled environment.

For example, a home occupant can operate the wireless device to receive a recorded or live video about detections in the home from any location within the controlled environment. The video can be presented on a display coupled to the wireless device or a monitor within the area that the home occupant is located. Accordingly, the home occupant would be able to watch a television program while lounging and enabling security monitoring. Additionally, the home occupant would be able to view detection video from a baby monitor with/without camera or a security camera on the wireless display device or another display, such as a wireless notepad, cell phone screen, desktop computer, television screen, etc.

In other embodiments, a home occupant is able to view or listen to media and detected data being presented on other televisions, personal televisions, and/or audio systems. As such, current home occupant can monitor their homes through television programs via web sites, and/or audio/video recordings that could be viewed by other children in other rooms. The present invention includes protocols that enable the current home occupant to block access to objectionable content for detection.

In other embodiments, a home occupant is able to access the centralized control server command and enable control through an external interface, such as the Internet. A home occupant is able to gain access to devices, destination and/or applications that are located within the controlled environment while the home occupant is at work or away from home. Therefore, the present invention permits a home occupant to log into the controlled environment and download or store data, receive feeds from the high definition interactive television sever serving as surveillance equipment, and open or secure locks on entry ways, or the like.

The present invention is implemented in residential, commercial/industrial and/or non-residential, commercial/industrial controlled environments. By way of example, the following embodiments are described with reference to a residential, commercial/industrial environment. However, it should be understood that the following embodiments could be modified to include non-residential, commercial/industrial, industrial environments as well.

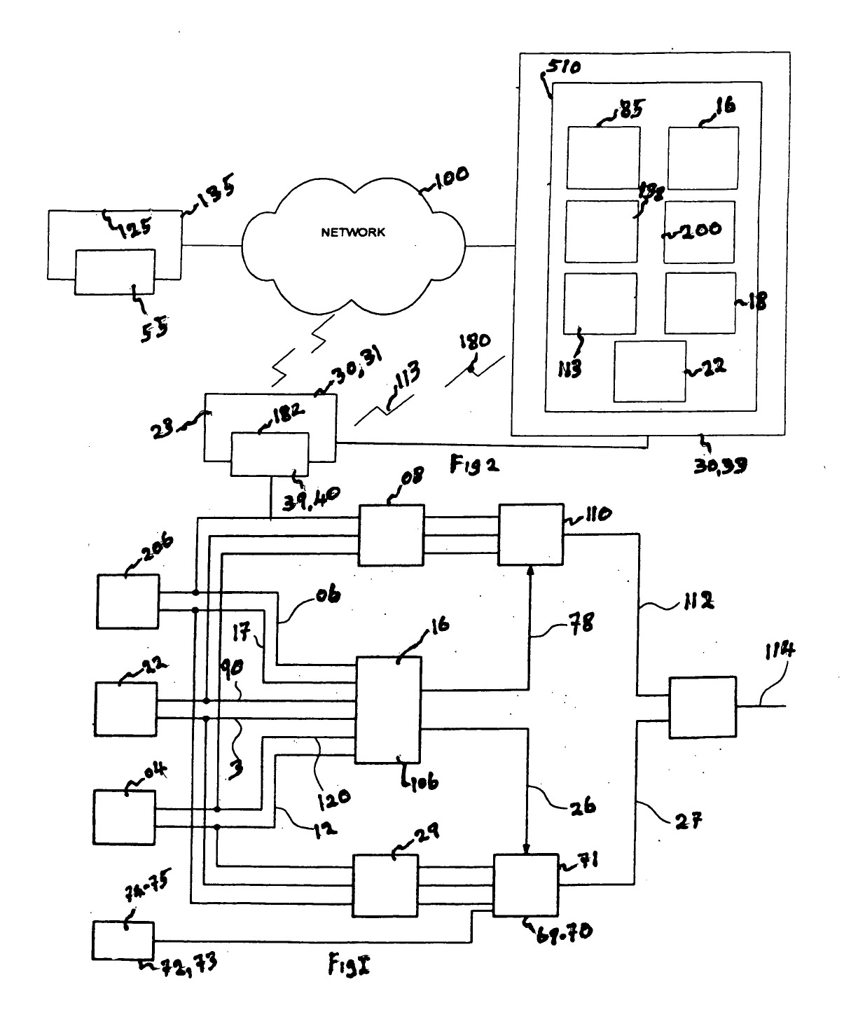

Referring to FIG. 1 is an illustration of a server network control system 10 according to an embodiment of the present invention. The present invention contemplates analog and digital environments. System 10 is an innovative, inexpensive, and versatile residential, commercial/industrial network. As shown, system 10 includes a communications network 80 and/or Internet that interconnects a plurality of detection and optical components to enable the network. The system components include a telephone means 12, a positioning unit 120, a computer 16, a camera 18, a control module 20, a television 22, a control server 24, a monitor 28, a voice auditory/audio means 118, and residential and commercial/industrial application software 26. Other devices, destination and/or applications can also be included as a system component.

Functionally, the components of the interactive detector 122 may be broadly grouped as being either digital signal components or optical isolating component for detection. These components could be embedded in computers 106 and computer peripheral components and RF modulating audio and/or video signal components forming the interactive detector 122. Generally, the media and detected data components of the interactive detector 122 include the computer components of the interactive detector 122 for enabling communication in serial digital signal format. The media and detected data components of the interactive detector 122 include either analog or digital signal outputs. All of the components of the interactive detector 122 enable signals to be transmitted together with the received broadcasting signals indicative of collectively enabling transmission through the network in a shared mode, such as is seen in one of three networks allocated frequency bands.

The frequency band includes a 5.0 to 42.0 MHz band dedicated to the Data Over Cable Service Interface Specification (DOCSIS) for upstream digital signal communications between a home occupants personal television 22, computer 16 (PC) and the cable service provider's server, enabling the CATV broadcast band ranging from 55.24 MHz (CATV channel 2) to 997.25 MHz (CATV channel 158). In the present network for the invention, a portion of each broadcast signal spectrum both CATV and UHF broadcast television are reserved for internal network use as modulation frequencies for the media and detected data signals, which are transmitted through the network. The media and detected data signals include both audio and video content as may be available from the network connection components forming the interactive detector 122. At 150 square feet at least detection from at least an interactive detector 122 is positioned within an environment, a signal distribution length is received from at least 15 dB 600 MHz attenuated substantially to 0 dB. The active gain shaping counteracts the high frequency attenuation and provides a usable signal-to-noise ratio signal up to CATV channel 85 at approximately 600 MHz, which is beyond the network reserved RF spectrum. The RF amplifier 124 is connected to the CATV for empowering communication signals and has substantially flat gain from 50 MHz to 1000 MHz and 75 ohm characteristic input/output impedance. The impedance matches the characteristic impedance of the broadcast signal coaxial line 1 and the network's signal conductors 30-33 as seen in FIG. 1.

The amplified broadcast signals are presented on line 2 to known type slope equalization circuitry 55 assigned specifically to communicate with home occupants and security agencies. As the signal frequency increases the output loading is reduced and the shunt inductor reactance increases with frequency, thereby substantially reducing the attenuation of the higher signal frequencies. The gain shaped and notch filtered broadcast signals are presented at the output of the slope equalization circuitry on lines 3. The signals on lines 4,5are presented through high pass frequency filters 67, 68 to network terminals 30, 31 where they are distributed by conductors 24, 25 to the components of the interactive detector 122 in locations 39, 40 as seen in FIG. 1. The high pass filters provide low impedance coupling of the broadcast signals to the network terminals while also blocking the low frequency signals that are simultaneously coupled to the terminals 30, 31 through low pass filters 69, 70 from the low frequency bus 71.

Conversely, low pass frequency filters 69, 70, having a nominal −3 dB frequency filter with a frequency range of 4.5 MHz, blocks the conditioned broadcast signals from the BALUM 80 from being coupled onto the low frequency bus 71. The low frequency bus 71 carries the low frequency detection data and information band signals and enables the command and control band signals which are coupled between each of the network terminals through low pass filters, such as the filters 69, 70 associated with the network terminals 30, 31. The BALUM 29 couples the high frequency signals through high pass frequency filters 72, 73, which are substantially similar to the high pass filters 67, 68 for the network terminals 26, 27 as shown in FIG. 1. Similarly, low pass frequency filters 74, 75, which are substantially similar to low pass filters 69, 70, block the high frequency broadcast signals from passing through to the low frequency bus 71 when detection is enabled.

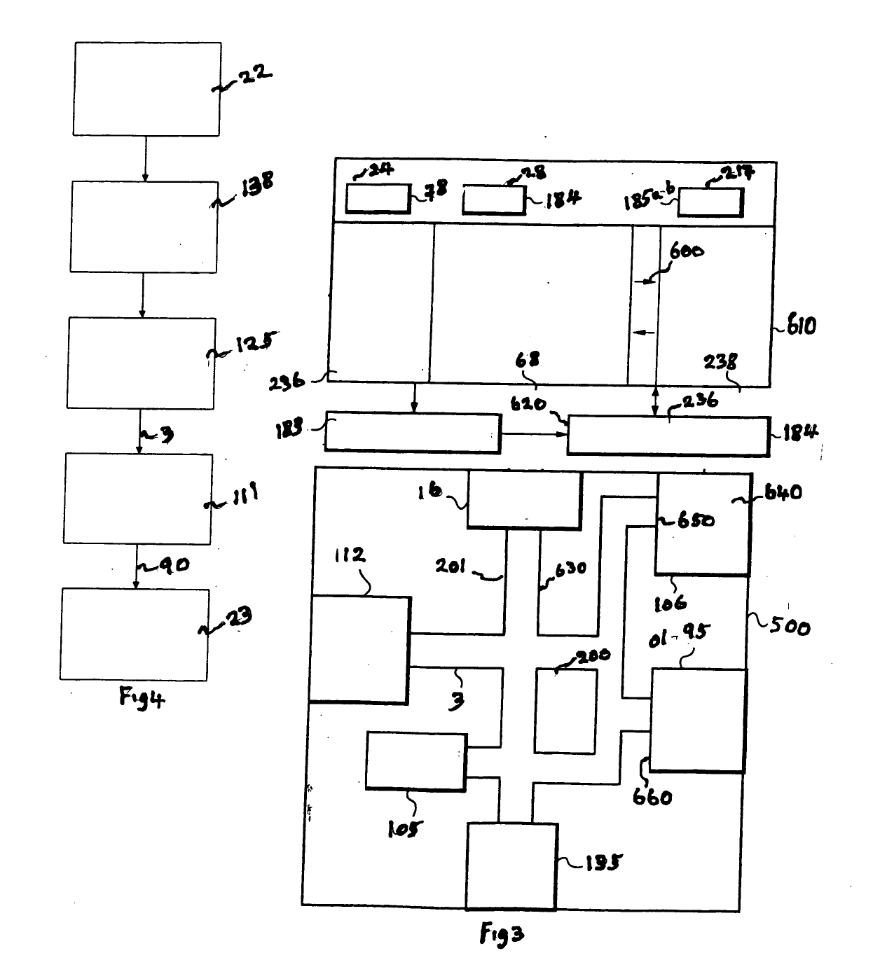

In an embodiment, control server 24 is configured to support various operating systems or interchangeable operating system. Control server 24 is operable to query, receive, and/or write to various archival and/or retrieval components. The archival and/or retrieval components can be internal and/or external to control server 24, which is configured to receive compressed streams, filter the streams for metadata such as, date, time, source, etc., and store the streams and metadata for future retrieval. FIG. 2 shows control server 24 connected to various archival and/or retrieval (A/R) components according to an embodiment of the present invention. The A/R components include a media and detected data archive 04, a secondary control server 23, a DSS box having human body heat sensor 206, a cable box 17, a media and detected data recognizer 06, and a media and detected data analyzer 08, and other detection devices. The aforementioned archival and/or retrieval components are not intended to be an exhaustive listing. Other archival and/or retrieval components can be implemented and are deemed to be within the scope of the present invention.

The archival and/or retrieval components can be centrally located in the homes/offices, widely distributed throughout the home/offices and residence, or accessible from an external source such as, a web server device having communicating means over the global Internet via a network connection 90. Network connection 90 include a wired and/or wireless LAN or wide area network (WAN), such as an organization's intranet, a local internet, the global-based Internet including the World Wide Web “WWW, “an extranet, a virtual private network, licensed wireless telecommunications spectrum for digital cable and cell including CDMA, TDMA, GSM, EDGE, GPRS, CDMA2000, WCDMA FDD and/or TDD or TD-SCDMA technologies, or the like. Network connection 90 includes wired, wireless, or both transmission media, and detecting data means includes satellite, terrestrial such as fiber optic, copper, UTP, STP, coaxial, hybrid fiber-coaxial “HFC”, or the like, radio, free-space optics, microwave, and/or any other form or method of transmission.

Media and detected data archive 04 provides one or more storage mediums for various data including video and audio, and metadata. In this embodiments, media and detected data archive 04 includes a removable storage unit such as a zip disk, floppy disk, CD-ROM, etc. To support larger volumes of detection content, one or more integrated databases or a data warehouse system is used to store the content and support the control server 24. In the embodiments, media and detected data archive 04 includes a relational or object oriented “OO”/component based database management system, or the like, that controls the analyzer, storing, retrieving, and updating of relevant data and metadata in the database records. The database management system also controls data integration, enforces integrity rules and constraints including detection data integrity and detection data referential integrity, and enforces security constraints.

Still in this embodiments, media and detected data archive 04 is a scalable system that stores data on multiple disk arrays. Detection and communication data warehousing can be implemented with at least the SQL Server 2000 application, which is available from Microsoft Corporation, the Oracle 9i.™. Database system is available from Oracle Corporation “Redwood City, Calif.” or the like. Yet in this embodiments, media and detected data archive 04 supports Open Database Connectivity “ODBC” and/or Java Database Connectivity “JDBC” protocols. The media and detected data archive 04 further include an index file database system and/or a planner file database system.

Secondary control server 23 receives audio and/or video signals from television and/or interactive security detectors. Secondary control server 23 is one or more individual radio and/or television tuners and programmer. In addition to receiving interactive broadcast detection signals, control server 24 is also configurable to support recording capabilities. Detection communications are broadcast and/or recorded to media and detected data archive 04. The control server 24 includes one or more record/playback applications or devices such as media and detected data analyzer 08 and media and detected data recognizer 06. Media and detected data analyzer 08 can be a VCR distributor, DVD distributor, PVR, video server, virtual recorder, audio server, stereo, CD distributor, record distributor, audio tape or cassette distributor, digital audio tape recorder, and/or any other device or application that stores, records, generates, or plays back via magnetic, optical, electronic, or any other storage media.

Media and detected data recognizer 06 records and plays back media and detected data and/or multimedia and detected data similar to media and detected data analyzer 08 functions. However, media and detected data recognizer 06 is capable of loading multiple recordings such as CD, DVD, etc. to be played without having to be reloaded.

Control server 24 provides centralized command and control of various functions within a controlled environment, such as system 10. The functions that are managed by control server 24 include video serving, audio serving, telephony, messaging, file sharing, Internet access, and security. According to other embodiments of the present invention, a home occupant operates control module 20 to establish or re-configure these functions and/or receive media and detected data from control server 24 or other system components, either directly from the system components or indirectly from the system components via control server 24.

FIG. 3 illustrates an embodiment of control server 24. Control server 24 includes wired/wireless communication links to various controller modules for security programming, monitoring, and for various system functions. Moreover, control server 24 includes application software to enable a video controller 106, an audio controller 108, a telephony controller 110, and a messaging controller 112, a file sharing controller 114, an external network interface controller 312, and a security controller 116. The controller modules are enabled to exchange signals with other system components via communications network. The controller modules are also enabled to exchange communications with other A/R components. As described with reference to FIG. 2, the A/R components include media and detected data archive 04, secondary control server 23, DSS box 15, cable box 17, media and detected data recognizer 06, media and detected data analyzer 08, and/or the like.

Control server 24 manages the distribution of information among other system components. As described in greater detail below, control server 24-interacts with the other components to directly or indirectly distribute data including audio and/or video, voice, and/or control messages over communications network 80 and/or Internet. In an embodiment, control server 24 commands and controls the operation and/or functions of one or more of the other system components.

Telephone means 12 is one or more wired and/or wireless telecommunications devices, communication route and destination means. Telephone means 12 exchanges telecommunications signals over conventional residential, commercial/industrial telephone paths and communications network 80 and/or Internet. In an embodiment, telephone means 12 implements a voice over Internet Protocol (VoIP) to exchange voice communications over a television network whether wired/wirelessly or in connection with a computer means such as the global Internet, and makes the voice signals available to communications network 80 and/or Internet. In an embodiment, telephone means 12 includes facsimile functions.

Positioning unit 120 includes interactive detector 122 as described in Pat. No. 6,762,686 and designates spatial locations within the offices and residence that serves as the hosting environment for system 10. Positioning unit 120 is coupled to the other system components such as the control server 24 via a wired and/or wireless interface. Positioning unit 120 is operable to designate by coded means, a floor or room assignment within the offices and residence. Positioning unit 120 is also operable to designate a specific location within a floor or room. Moreover, positioning unit 120 can be situated inside/outside of the offices and residence to thereby, designate external areas of protection for the offices and residence. In an embodiment, positioning unit 120 is coupled to another system component. In another embodiment, multiple positioning units 120 are distributed throughout the offices and residence. For example, the positioning units 120 can be located within, or mounted to, a wall, door, ceiling, floor, or the like.

Computer 16 includes a wired and/or wireless personal television, personal digital assistant (PDA), enhanced telephone, personal television, or other data processing device linked to communications network 80 and/or Internet. As a personal interactive high definition television, computer 16 can be a desktop, cell phone, notebook, notepad, or the like. A display is coupled to computer 16 to provide a text or graphical home occupant's interface (GHOI) and enable a home occupant to interactively communicate with control server 24. Input and output devices are interactively coupled to enable data destination for computer 16 and include a keyboard, cell phone, mouse, verbal command interface, mouse wheel, joystick, rudder pedals, touch screen, microphone, joystick, stylus, light pen, or any other type of input output peripheral unit.

Camera 18 is one or more video cameras, camcorders, or the like, interactively positioned in at least a detector means, at least an entertainment means, and communicatively connected to the control server. The present invention contemplates both wired and wireless devices for allowing detection and enabling signal destination. Camera 18 may represent part of the detectors for home security or monitoring system, such as a television screen, a computer screen, a baby monitor with/without camera, etc. In an embodiment, camera 18 is wired/wirelessly connected to a position unit 14, and includes a control unit that enables remote control of various camera functions, such as pan, tilt, zoom, focus, iris control, etc.

Control module 20 is a wired and/or wireless data processing device that enables a home occupant to interact with the detection systems and send control messages to control server 24 and the other system components. Control module 20 can be a wired or wireless version of the devices destination means listed as computer 16. For example, computer 16 can be cell phone, personal notebook or notepad computer, PDA, enhanced telephone, or other devices configured with capabilities that are linked to communications network 80 and/or Internet, including a display device with the ability to interact with the other system components. Hence, control module 20 enables a home occupant to remotely control the operations of various components of system 10. In an embodiment, the display for control module 20 is capable of receiving video, text, and/or audio from the other system components. In another embodiment, control module 20 includes a flash ROM that enables wireless downloads and/or uploads of data about sections of the home or detection environment.

Television 22 is a conventional television having embedded cameras with all features focused for enabling interactive detection and communication. In another embodiment, television 22 is enhanced to support interactive and/or personal services. Personal services include monitoring, virtual recording, programming, pausing/rewinding live broadcasts, or the like. For example, television 22 can be a personal television with interactive means enhanced to support online communication and other radio frequencies transmission through web TV Networks or other conventional networks. Television 22 includes means for enabling communication through cable and/or satellite receptions and in connection to a device having at least a PVR, VCR, or DVD distributor/recorder.

Monitor 28 is a wired or wireless display that supports closed-circuit viewing. In an embodiment, monitor 28 is a flat LCD positioned on a wall or standing on a desk, table, or counter top, etc. In an embodiment, monitor 28 receives a streaming screen saver that displays static or dynamic images of a photograph, portrait, etc. when monitor 28 is functioning in an inactive state. In another embodiment of the present invention, monitor 28 receives feeds from a television, stereo, or security/monitoring system such as a baby monitor with/without camera.

Voice auditory/audio means 118 is a wired or wireless audio system, such as a cell phone, stereo, audio vice server, CD/record/cassette distributor, MP3 distributor, etc. Voice auditory/audio means 118 can be a microphone as part of a security/monitoring system, such as interactive alarms “Pat. No. 6,762,686” a baby monitor with/without camera. In an embodiment, a voice auditory/audio means 118 includes one or more speakers with audio outputs located throughout the offices and residence. In another embodiment, a voice auditory/audio means 118 is an intercom system, public/office announcement system, door answering service, or the like.

Communications network 80 and/or Internet provide a transmission medium for communicating among the system components. In embodiments, control server 24 polices all traffic among the other system components. As such, the exchange of information among the system components is routed or otherwise controlled via control server 24. In another embodiment, communications network 80 and/or Internet supports peer-to-peer communications. As such, the system components exchange audio, video, and other detection data, and/or control messages directly with each other and without being centrally managed by security control server 24. Therefore, the present invention can be implemented without control server 24. In such one aspect of de-centralized embodiments, the control and management functions for the communications network 80 and/or Internet are distributed and shared by multiple system components so that the system components can communicate with each other over a wired and/or wireless medium without a central control server 24.

Communications network 80 and/or Internet are a wired and/or wireless local area network (LAN). Thus, communications network 80 and/or Internet includes wired, wireless, or both transmission media for detected data, including satellite, terrestrial such as fiber optic, copper, UTP, STP, coaxial, hybrid fiber-coaxial (HFC), or the like, radio, microwave, free-space optics, and/or any other form or method of transmission not mention at this time.

In an embodiment using a wired transmission medium, communications network 80 and/or Internet are Ethernet LAN capable of supporting one hundred Mbps to one Gbps. Still in an embodiment, a CAT-5 cable, or the like, is coupled to control server 24 and is distributed to a location within each room. Yet, in an embodiment, the cable is distributed to each system component, such as television 22, monitor 28, etc. The system component includes an audio/video (AV) connector that is responsive to receive the cable.

In an embodiment using a wireless transmission medium, communications network 80 and/or Internet supports the IEEE standard 49.11(a), which specifies a wireless Ethernet protocol for large-sized video. Using this protocol, communications network 80 and/or Internet can handle up to fifty-four Mbps with an effective range of ninety feet. In another wireless embodiment, communications network 80 and/or Internet supports the IEEE standard 49.11(b), which specifies a wireless Ethernet protocol for small-size video. With this wireless protocol, communications network 80 and/or Internet are effective for ranges approximating 150-300 feet, and capable of supporting nominal bandwidth of 11 Mbps, with 4-5 Mbps effective bandwidth.

In an embodiment, communications network 80 and/or Internet include a telephone line and/or power line. In another embodiment, communications network 80 and/or Internet enables conventional electrical outlets and wiring to interconnect the system components and enable them to communicate with each other. In still another embodiment, communications network 80 and/or Internet include communications technologies made available from the Home Phone and cable Networking Alliance or the like. Home technologies are communicatively configured to enable the operation of telephone services to log into the server system and capture detection data when detection is enabled and home networking allows agencies such as Police, Homeland security, Fire department to log into the home desiring emergency. The networking environment includes, but not limited to, video conferencing, video security, VoIP telephony security, digital video networking, Internet sharing, and multi-home occupant data environment.

Communications network 80 and/or Internet include a central control server 24 to enable the system components to communicate with each other. In embodiments of the present invention, a detection platform 500 that is small in physical size, has access to power lines for continuous and uninterrupted electrical power and physically located within the system to facilitate transmission and reception of wireless signals suitable for providing housing, hosting, or the like and for enabling detection through central control server 24 as shown on. FIG. 11. The figure illustrates an embodiment of High Definition Server Network Control System 10 (HDSNCS) that includes a wireless network access point 180 as a detection platform for home occupants and in communication with control server 24. The detection and communication configuration for the wireless access point 180 provides control server 24 with a central point of connectivity in a wired/wireless network environment, enabling connectivity necessary for tracking states/status of the system components. Additionally, detection and communication configuration for the wireless access point 180 can provide a connection point between a wired and wireless network and the home occupant at remote locations.

In FIG. 11, the system components include control module 20, television 22, a media and detected data distributor 113, and a cable box 17. Other system components having external control interfaces such as cable or IR can be included, such that telephone means 12, interactive detectors 122, control system 10, positioning unit 120, computer 16, camera 18, control server 24, monitor 28, a voice auditory/audio means 118, residential, commercial/industrial application software 26, and the like are configured to enable interactively communication through wired/wireless means.

The network illustrated in FIG. 11 also includes an infrared/serial bridge 128, having detection means, and in communication with the control module 20, and control server 24. In an embodiment, Infrared/serial Bridge 128 complies with the IEEE 49.11(b) standard for wireless communications. Infrared/serial bridge 128 exchanges infrared signals with stand-alone system components, such as television 22, cable box 17 and media and detected data distributor 113 and also separates detection type by distinguishing a human body from other detections “Pat. No. 6,762,686.”

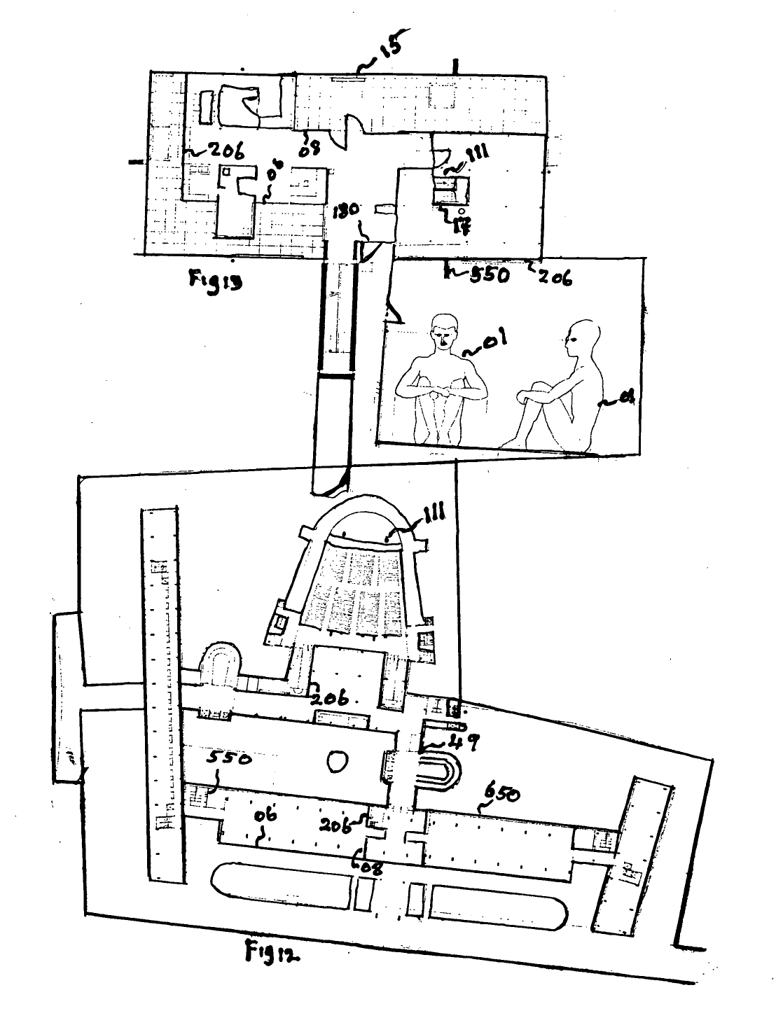

FIG. 12 illustrates another embodiment of server network control system 10, which includes a plurality of infrared/serial bridges 128(a)-128(e) for detection of human body in homes with plurality rooms, and enabling interactive communication there from. Each infrared/serial bridge 128(a)-128(e) interacts with one or more stand-alone components of the system such as fire alarms, control server 24, control module 20 or the like. As shown, infrared/serial Bridge 128(a) interacts with television 22(a), cable box 17, and media and detected data distributor 113. Infrared/serial Bridge 128(b) interacts with a tuner 1104 or any type of proprietary Ethernet device. Infrared/serial Bridge 128(c) interacts with a residential environment.

FIG. 13 illustrates another embodiment of server network control system 10, which includes a smoke detector 138. Smoke detector 138 includes a network interface card 182 which enables smoke detector 138 to serve as yet another platform for control server 24, providing the control server with Home-PNA and/or wireless (e.g., IEEE 49.11) network connectivity. By taking advantage of the smoke detector's location and access to power lines, the control server can send data and/or control messages throughout the controlled environment either through a cable and a wireless connection or through the power line. Since most smoke detectors are presently hard-wired into the home or office power line, the smoke detector platform also provides means of connectivity for control server 24. Another advantage of using a smoke detector as a detection platform for control server 24 is that smoke detectors can be ceiling/wall mounted to facilitate a greater communications range.

Control server 24 is one or plurality servers, with each server being one or plurality computers providing various shared resources with each other and to other system components. The shared resources include data for programs, web pages, databases and libraries, output devices, destination means such as, printers, plotters, display monitors and facsimile machines, communications devices, including other destination means, such as modems and Internet access facilities, and other peripherals such as scanners, etc. The communications devices, destination can support wired or wireless communications, including satellite, terrestrial such as fiber optic, copper, coaxial, and the like, radio, microwave, free-space optics, and/or any other form or method of transmission.

In another embodiment, control server 24 is configured to support the standard Internet Protocol (IP) developed to govern communications over public and private Internet backbones. The protocol is defined in Internet Standard (STD) 5, Request for Comments (RFC) 101 (Internet Architecture Board). Control server 24 also supports transport protocols, such as, Transmission Control Protocol (TCP), Home occupant Datagram Protocol (HODP), Real Time Transport Protocol (RTP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like to enable real time detection and communication.

The server system is configure with a video controller 106 that manages the exchange of video signals within system 10. Video controller 106 receives and/or distributes video signals for displays coupled to screens, for example, computer 16, television 22, monitor 28, control module 20, etc. Video controller 106 also interacts with the A/R components, such as, media and detected data archive 04, secondary control server 23, DSS box 15, cable box 17, media and detected data recognizer 06, media and detected data analyzer 08, network connection 90, etc. In still another embodiments, video controller 106 reads and/or writes to an internal storage medium that is designated for video in addition to or in lieu of the A/R components.

Accordingly, video controller 106 receives video signals from the A/R components and/or its internal storage medium and distributes them to other system components such as television 22, control module 20, etc. Video controller 106 can also receive a video stream from a source such as a network connection 90, television 22, media and detected data archive 04, etc. and store the stream in one of the A/R components such as media and detected data archive 04, media and detected data analyzer 08, etc. and/or its internal storage medium for future references and/or viewing. For example, video controller 106 can query a web site such as “www.bet.com” to download a music video to be played and/or stored to a system component while also checking for ongoing security at a current bet show. To enable distribution over communications network 80 and/or Internet, video controller 106 provides MPEG encoding according to embodiments of the present invention. Video controller 106 is able to receive, encode, and distribute a media and detected data stream in real time or near term. In yet another embodiments, network connection 90 enables video controller 106, or like components, to implement broadband Internet access for audio/video distribution of security data.

Another controller module is audio controller 108. Audio controller 108 manages the exchange of audio signals within system 10. Accordingly, audio controller 108 receives and/or distributes audio signals for one or more audio components, such as, for example, a voice auditory/audio means 118 or speakers coupled to a computer 16, television 22, monitor 28, control module 20, etc. Audio controller 108 also interacts with the A/R components such as the secondary control server 23, DSS box 15, cable box 17, media and detected data recognizer 06, media and detected data analyzer 08, network connection 90, etc. to receive audio/visual signals from the A/R components and distribute them to other system components such as a voice auditory/audio means 118 and a control module 20, etc. Additionally, audio controller 108 can receive an audio stream from a source such as network connection 90, television 22, media and detected data archive 04, etc. and store the stream in one of the A/R components such as media and detected data archive 04, media and detected data analyzer 08, etc. for future recall. In embodiments, audio controller 108 reads and/or writes to an internal storage medium that is designated for audio, and hence distributes audio to and from its internal storage medium. For example, audio controller 108 can query a web site with links to the server system 24, like “MP3.com” to download a digital recording to be played and/or stored to another system component. In an embodiment, audio controller 108 encodes the audio stream to MPEG-3 format to produce near-CD quality in real time or near time. In another embodiment, audio controller 108 encodes the audio stream to produce detection data on CD quality audio in real time or near term.

Telephony controller 110 is another control module within the control server 24. Telephony controller 110 manages the distribution of telecommunications from conventional telephone paths and/or television network in connection with a computer means such as communications network 80 and/or Internet, network connection 90, etc. In an embodiment, telephone means 12 is coupled to a conventional wired or wireless telephone path, such as POTS or PSTN. Telephone means 12 can also be coupled to a cellular or satellite communications path. A dedicated interface 510 is provided to enable the cellular/satellite telephone means 12 to interact with system 10. Calls or signals received or transmitted over the conventional path are also monitored and/or controlled by control server 24. As such, control server 24 is responsive to distributing detection and communication signals from the calls or detection environment to other system components. For example, control module 20 is one potential recipient component. Hence, a home occupant is able to directly operate control module 20 to place and/or receive calls indirectly via telephone means 12 when a detection is enabled.

In another embodiment, telephone means 12 is coupled to a television network in connection with a computer means. Alternatively, a wired or wireless telephone that is coupled to computer 16 is capable of interacting with a television network in connection with a computer means. The television network in connection with a computer means is a LAN or WAN such as the Internet that is accessed via communications network 80 or network connection 90, or the system components such as telephone 102, computer 16 means, and can have a dedicated link to a television network in connection with a computer means, such that the link is independent of communications network 80. In an embodiment, the telecommunications signals are formatted for VoIP or the like. Irrespective of the source of the television network in connection with a computer means, the telecommunications signals from the television network in connection with a computer means are monitored and/or controlled by control server 24. As discussed with reference to conventional telecommunications calls and security detection, control server 24 is responsive to distributing signals from the calls and detection media to other system components, such as, for example, control module 20.

In addition to answering, placing, and/or distributing detection and telecommunications calls and detection data, control server 24 is operable to perform other telephony functions for distributing detection contents. In an embodiment, control server 24 supports speed dialing to detection storage media and directs cable communication services to the storage media. Telephone numbers of key members of the home occupants are stored in a memory 200 such as one of the A/R components described with reference to FIG. 2 coupled to residential, commercial/industrial control server 24. In another embodiment, control server 24 is programmable to implement service blocking. Home occupant will be able to create a profile to block telephone and detection data calls from a designated number or family or numbers. In yet another embodiment, control server 24 logs inbound/outbound communication signals and/or enables redialing past and/or missed calls to security agencies and/or home occupant.

Control server 24 also includes messaging controller 112, which enables centralized storage of telephone calls received via telephony controller 110 and the like. Voice messages are written to a memory 200 such as is contained in one of the A/R components described with reference to FIG. 2 coupled to control server 24. Messaging controller 112 also permits messages including audio, video, and/or text to be created, stored, and/or retrieved within system 10. In other words, a home occupant can operate one of the system components such as the control module 20, telephone means 12, a voice auditory/audio means 118, etc. to create a message for the same or another home occupant. Messaging controller 112 also enables control server 24 to interact with computer 16 or other system components to communicate, search and/or retrieve data from computer emails, enable instant messaging services when detection is eminent, and/or notes, tasks, reminders, and/or detection events from personal calendars.

Control server 24 also includes file-sharing controller 114. File sharing controller 114 enables control server 24 to function as a central file server for all personal televisions in communications with system 10. File sharing controller 114 permits data to be stored and accessed by system components located within the homes/offices and residence that is hosting system 10. In an embodiment, devices, destination located outside of system 10 is able to store and/or retrieve data via file sharing controller 114. That is, if a static IP address is sustained by the ISP for system 10, a remote home occupant could log into control server 24 to retrieve and/or store data via file sharing controller 114.

Control module 20 is another controller module in communication with control server 24. Control module 20 manages access to the system components from external devices, destination and/or applications, and/or access to external devices, destination, applications, and/or web sites from the system components. The control module 20 provides a gateway to external networks, such as the global Internet, other private WANs, or the like. In an embodiment, control module 20 supports web proxies and is configurable to block designated web sites into control servers or per home occupant request. In another embodiment, control module is operable to track and/or record access/visits to control server and sites to the system network. Control module 20 supports wired and/or wireless access to external networks, including cable and/or satellite ISPs. In an embodiment, control module 20 permits control server 24 to operate as a web server, provided the ISP is able to provide a static IP address.

Security controller 116 enables control server 24 to interact with and/or manage various security systems, including the communications to interactive detector 122 and cameras and communications security protocols for system 10. In an embodiment, security controller 116 controls and/or monitors feedback from system components that form a part of the security system. That is, a video camera 18 and voice auditory/audio means 118 and camera 18 can be captured and saved in server 24 in communication with control module 20 or monitor 28. Motion sensors can also be placed within the homes/offices and residence or in external locations surrounding the homes/offices and residence. Feedback from the motion sensors can also be transmitted to security controller 116. In an embodiment, such feedback activates cameras 80 and/or voice auditory/audio means 118 within the vicinity. In another embodiment, such feedback activates security alarm or signals the control module 20. To signal the home occupant, control module 20 can vibrate, ring, flash a message, or the like. Control systems coupled to camera 18 permits the security controller 116 to move and/or focus camera 18. In an embodiment, security controller 116 is operable to lock or unlock doors, windows, or entryways in response to home occupant's input.

In an embodiment, security controller 116 interfaces with fire and safety control system within the home/office. As such, sensors are feed into control server 24 and permit system 10 or a home occupant to log in and monitor emergency situations. Alarms, sprinkler systems, and the like can be operated via control server 24 and/or control module 20. A home occupant can be authorized via security controller 116 to log into control server 24 over the Internet from a remote location and receive live feeds from camera 18, archived feeds from camera 18, broadcasts feed from television 22 messages stored via messaging controller 112, data stored via file sharing controller 114, or the like.

Control server 24 is not limited to the functions depicted in the embodiment. Control server 24 can include other modules for controlling the operations and functions of the various system components for enabling home security monitoring and activation through a home occupant's remote-control commands, including functions of a communication device. In an embodiment, control server 24 can set or synchronize a clock for one or more system components, including the A/R components. Control server 24 includes a real-time clock that can be set by a home occupant through a direct control module interface with control server 24 or through another system component, such as secondary control server. Alternatively, the real-time clock can be set via the Internet through network connection 90. Control server 24 uses its own real-time clock to set the clock of other system components by navigating the menu system of the respective system component. Since control server 24 tracks and monitors the state of the system components, control server 24 is programmable to navigate the menus of the system component to set the clock without interfering with the component's operations, such as when a television is on.

Instructions for navigating a system component are stored in a database or similar library coupled to control server 24. In other words, the input numbers for navigating the menus of a VCR or DVD distributor to set or program its internal clock can be memorized. The memorized numbers are associated with a set of IR codes, which are stored at control server 24. At the appropriate time, the IR codes are retrieved from the IR code database or library, and transmitted to the appropriate media and detected data analyzer 08. Upon receipt, the IR codes are executed to navigate the menus to set the clock or retrieve detection data content. IR codes can also be selected to program media and detected data analyzer 08, to record select programs detection and the like.

In addition to setting the configuration of system components, control server 24 governs the addition and/or deletion of system components to server network control system 10. In an embodiment, an environment profile is established to track and monitor all devices, destination and/or applications within a specified environment of the controlled environment of the home. A text-based or graphical home occupant interface enables a home occupant to specify the location or dimensions of an environment for monitoring. An environment can be one or more rooms or designated areas within a room. The present invention can also be used to control the operations and functions of system components located within the surrounding area of a home.

Once an environment is established, the home occupant can specify the system components that will governed the environment and enable communication with the control server 24. The system components are in automatic communication with the network 100. A system component announces its presence by broadcasting a detection control message on a continuous or periodically scheduled basis. Control server 24 receives the broadcast and adds the system component to the profile for that particular environment by extracting a detection type and properties for the system component from the detection message. The system component can be automatically interfaced with the environment profile. The home occupant can expressly accept the profile change, or ignore it thereby allowing the profile change to be automatically approved. With respect to updating pro-data, control server 24 can also explicitly enable a request through at least one of the broadcast mechanism that all system components in an environment identify themselves through.

The server network control system tracks and/or monitors the positions of various objects and system components within the home, offices, and residential environment in real time. When a home occupant migrates within the controlled environment that hosts system 10, the present invention can implement several protocols to enable detection within system 10 to determine a location of an intelligent object or the component and the location of any home occupant presence during an emergency by enabling communications with the intelligent component, such as the interactive detectors. A control server 24 has a processor in communication with the intelligent component for enabling determination of the current location of the intelligent component, and sends instructions to reconfigure the intelligent component to control other system components within specified vicinity. When a control module 20 is determined to be located within a dining area and enabled, the control server 24 will then be allowed to control the control module 20 to enable controlling system components positioned in the dining area responsive for video recording and close-up shots.

Positioning devices are utilized in several embodiments of the present invention for tracking and/or monitoring intelligent components. As described above one or more positioning units 120 are distributed throughout the controlled environment that hosts system 10. The positioning units 120 can be coupled to an intelligent component such as a control module 20, a voice auditory/audio means 118, telephone means 12, or located as a stand-alone device within the controlled environment.

In another embodiment, positioning unit 120 is part of a RF communications system 520. That is, a RF transponder 125 interacts with a RF interrogator 135 to communicate positioning information. The transponder is coupled to a system component and makes available identification information that uniquely identifies the system components and detection types. The transponder 125 can make available other types of information, including an assigned location of the system component if the component is a stationary or infrequently moved device. Therefore, as described in further detail below, the transponder 125 can be coupled to either one of the intelligent component or a positioning unit 120.

The transponder 125 can be active or passive. An active transponder transmits a continuous or periodic signal containing the identification information. A passive transponder remains inactive and/or silent until it is activated by detection, an interrogator, or manually activated by a home occupant. Therefore, the system component can operate in a silent mode or active mode. In active mode, the position of the system component is being tracked and/or monitored in real time or near term. In silent mode, the current position of the system component is not known to system 10 with absolute certainty until the transponder 125 is activated.

The interrogator 135 is coupled to another system component and receives positioning information when it comes within the communications range of the transponder 125. The interrogator 135 will automatically receive the positioning information from an active transponder, or will activate a passive transponder to receive the positioning information.

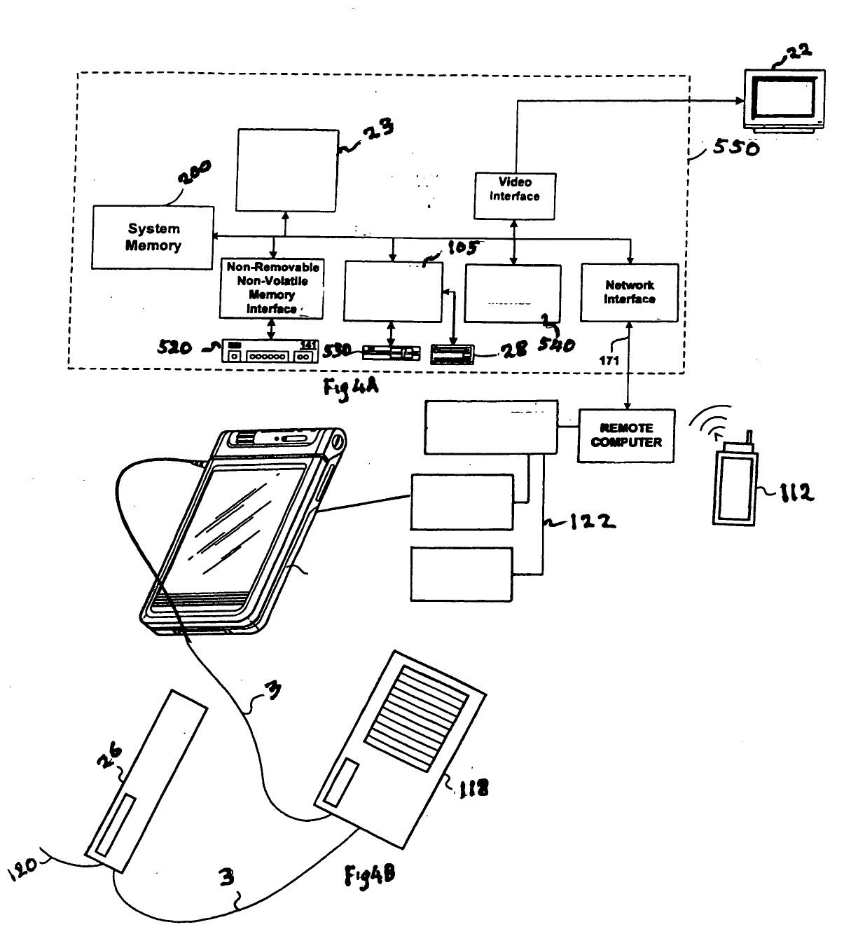

The interaction between a transponder 125 and an interrogator 135 can be explained with reference to FIG. 4A and FIG. 4B. FIG. 4A illustrates an embodiment for positioning system components within system 10. A transponder 125 is coupled to control module 20, and an interrogator 135 is coupled to or embodied within positioning unit 120. When a home occupant 01 carrying control module 20 enters the vicinity of positioning unit 120, positioning unit 120 receives identification codes from control module 20. The identification codes include an identifier for the transmitting control module 20, or the like. In an embodiment, positioning unit 120 sends the identification codes to residential, commercial/industrial control server 24 for further processing. Positioning unit 120 can also send other identification codes or information with the identifier to the control module 20. In an embodiment, positioning unit 120 sends a vicinity identifier 550 or the like data in response to detection of at least an object, wherein the object is responsible for the activation of devices in environments of the residential, commercial/industrial environment where positioning unit 120 is located. In another embodiment, control server 24 determines the vicinity identifier 550 from an identifier assigned for the positioning unit 120.

FIG. 4B illustrates another embodiment for positioning a system component within system 10. As shown, transponder 125 is coupled to or embodied within positioning unit 120. Interrogator 135 is coupled to control module 20. Therefore as home occupant 01 carrying control modules 110 enters the vicinity of positioning unit 120 such as transponder 125, control module 20 receives identification codes from positioning unit 120 in response to any detection. The identification codes include an identifier for the transmitting positioning device 104, a vicinity identifier 550 for the environment in which detection was enabled such as, floor, room, etc. of the controlled environment, or the like. In yet another embodiment, control module 20 processes the identification code to determine its location and/or sends the identification code to control server 24 responsive for enabling transmission or for archival purposes. In another embodiment, control module 20 sends the identification code to control server 24 to determine its location and for further processing. Again, control module 20 has been described by way of example. Other system components can also be coupled with an interrogator 135 and, thereby, configured to have other locations determined by embodiments of the present invention.

In an embodiment, transponder 125 is an electronic tag, beacon, controller, or the like. The electronic tag is characterized as having any shape or size, and is located on, or integrated within, the system component. The electronic tag includes a microprocessor 105 connected to enable communication with the communications circuitry that supports RF communications with other devices responsive for dialing other destinations. The microprocessor 105 is coupled to a memory 200 responsive for storing and communicating information such as identification information to control server 24, and transceiver responsive for exchanging information with the other devices to distant destination.

In still an embodiment, transponder 125 has a dedicated microprocessor 105 for transmitting positioning information. In another embodiment, transponder 125 utilizes or shares the microprocessor 105 for the hosting system component such as the control module 20 to enable exchanging object positioning information. For example, the hosting system component would include an infrared port that is coupled to a microprocessor 105 and memory 200 located in the system component. The memory 200 includes the identification information and all related data. The microprocessor 105 interacts with the memory 200 and infrared port to support exchanges with interrogator 135. As such, the interaction among the microprocessor 105, memory 200 and infrared port serves as transponder 125 and indicative of responding to detection data. Wireless communications between transponder 125 and interrogator 135 are supported by various interchangeable technologies. In an embodiment, the Bluetooth™ wireless technology is used to implement a short-range wireless interface between transponder 125 and interrogator 135.

In lieu of, or in addition to RF communications, and the incorporation of RFID chip for detection and for transmitting and receiving signal communication, positioning unit 120 in the embodiment further enables data collection using at least a bar code through system 10. In other words, a bar code is disposed to at least a detection system's component and stores identification information that uniquely identifies a specific detection type within the system component and location. As described with reference to a transponder, the bar code can store other types of information, including the assigned location of the system component if the component is a stationary device. A bar code scanner collects the identification information so that the information can be processed to determine the location of the system component.

Bar code data collection can also be described with reference to FIG. 4A and FIG. 4B. In other words, interrogator 135 is a bar code scanner and transponder 125 is a bar code according to embodiments of the present invention. Referring back to FIG. 4A, a bar code transponder 125 is disposed to control module 20 and a bar code scanner 126 is disposed to or embodied within positioning unit 120 having embedded sensors. As home occupant 01 carrying control module 20 enters the vicinity of positioning unit 120 such as a bar code scanner 126, the positioning unit 120 receives the identification codes containing an identifier for the control module 20. As described above with reference to an interrogator, the identification codes, with or without a vicinity identifier 550, are sent to control server 24 for further processing. Although control module 20 has been described by way of example, other system components can also be coupled with a bar code transponder 125 and, thereby, configured to have other locations determined by embodiments of the present invention.

Referring back to FIG. 4B, another embodiment for positioning system components with bar coding is illustrated. As shown, bar code transponder 125 is disposed to or embodied within positioning unit 120, and a bar code scanner 126 is disposed to control module 20. When home occupant 01 carrying control module 20 enters the vicinity of positioning unit 120 such as bar code transponder 125, control module 20 receives the identification codes containing an identifier for the transmitting positioning unit 120. As described above with reference to a transponder, the identification codes, in an embodiment, includes an identifier for the transmitting positioning device 104, a vicinity identifier 550 for the environment of the residential, commercial/industrial environment, or the like. The identification codes, with or without a vicinity identifier 550, are processed by control module 20 to determine its location, and/or sent to control server 24 as seen in FIG. 1, for further processing. Although control module 20 has been described by way of example, other system components can also be coupled with a bar code scanner 126 and, thereby, configured to have other locations determined by embodiments of the present invention.

The utilization of RF and bar coding technologies in home security environment represents alternative methodologies for detecting, tracking and/or monitoring the location of system components. As would be apparent to one skilled in the relevant art, other positioning technologies can also be implemented with the present invention. For example in larger scaled environments, the use of at least GPS receivers, cellular signals, and triangulation or the like is available alternatives.

In another embodiment, positioning means can be realized without the use of positioning unit 120. Control module 20, or the like is responsive for receiving and processing commands from the home occupant operating control means 111. The commands are manually and/or verbally entered into control means 111. Control module 20 processes the commands, or sends the commands to control server 24, to determine the location. For example, the home occupant can specify the location for example “living room,” and the control module 20 would be profiled to activate control devices to enable data transmission to other destination within the living room, within the home, and external to the home.

In another embodiment, nano sensors are profiled to detect and communicate and configured with the control server 24 to further enhance centralize communication. In still another embodiment of the present invention, a MEMS 570 is structurally profiled with a RFID chip 580 and configured with a control server 24 to enable detection and communication. Other aspects of the invention are seen to include the intelligent components comprising at least a nano technology, including nano sensors configured to enable improved detection and communication.

In another embodiment, however, voice and/or manual commands can be entered into positioning unit 120 or the like. The home occupant would also enter an identifier for the intelligent component (e.g., control module 20), and position unit 14 would send control signals to control server 24, or the like, to update the location records of intelligent component.

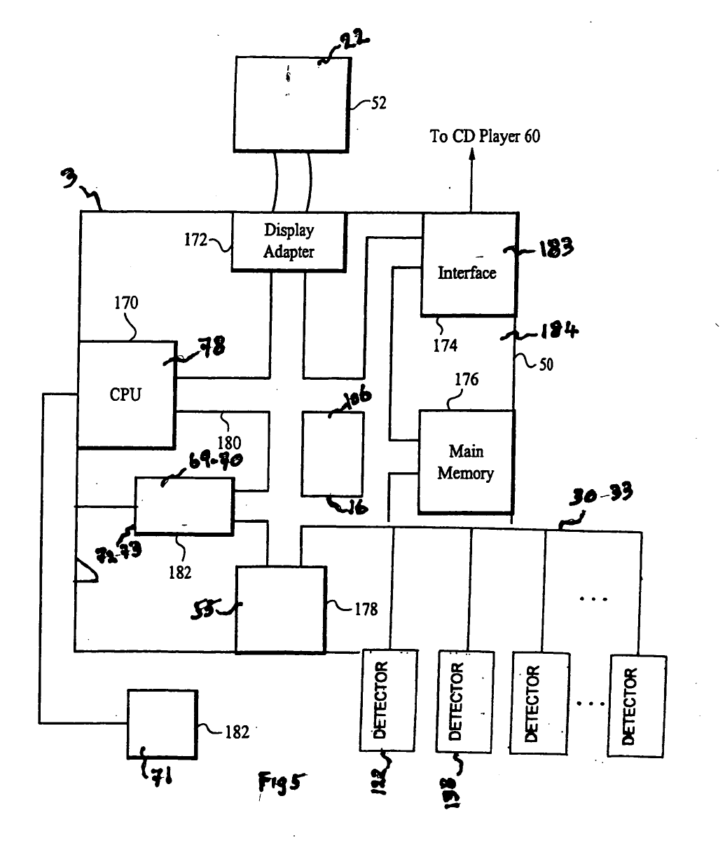

As described above, the present invention supports various protocols for gathering detection data and location information. The present invention provides several methods and/or techniques for processing the location information to track and/or monitor the position or movement of various components of system 10. Referring to FIG. 5, FLOWCHART 100 represents the general operational flow of an embodiment of the present invention. More specifically, FLOWCHART 100 shows an example of a control flow for tracking and/or monitoring system components within a controlled environment.

Referring to FIG. 5, the control flow of FLOWCHART 100 begins at mode 01 and passes immediately to enable detected data to mode 03. At mode 03, an appropriate component of system 10 accesses locator codes that correspond to a system component such as intelligent component that is being tracked and/or monitored. Referring back to FIG. 1 and FIG. 2, the present invention can determine the current position of any of the aforementioned system components, including, but not limited to, telephone means 12, positioning unit 120, computer 16, camera 18, control module 20, television 22, control server 24, monitor 28, video cameralO7, and a voice auditory/audio means 118, residential, commercial/industrial application software 26, media and detected data archive 04, secondary control server 23, DSS box 15, cable box 17, media and detected data recognizer 06, media and detected data analyzer 08, and/or other devices that would enable sharing data to other destinations and/or other device applications.

As described above, the present invention includes various embodiments for accessing locator codes and/or a vicinity identifier 550. For instance, in the described embodiment, a home occupant interacts with a text or graphical interface to manually enter the current location for an intelligent component. In another embodiment, a voice command interface enables the home occupant to enter voice commands for an intelligent component responsive for enabling verbally communicating through devices in current and distant location indicative of enabling communication to intruders from remote locations.

In an embodiment, an intelligent component interacts with positioning unit 120 to access locator codes. Referring back to FIG. 4B, the intelligent component being at least a control module 20, is coupled to interrogator 135. Interrogator 135 polls positioning unit 120 for a vicinity identifier 550. The vicinity identifier 550 includes an infrared sensor 06 having locator codes responsive for identifying the current location of detection activities and for identifying the location of home occupants when detection is enabled for both or all system components.

Referring back to FIG. 4A, interrogator 135 is integrated with positioning unit 120 and connected to the control module 20 to enable interactive communication with an intelligent component. The intelligent component representing at least a control module 20 in communication with interrogator 135 and configured with plurality devices. As a result, interrogator 135 receives an identifier for communications with intelligent component to enable a locator code representing at least the vicinity where detection was enabled. The locator codes are then produced and transmitted by associating the identifier with the vicinity identifier 550 for the interrogator 135.

Referring back to FIG. 5 at mode 06, the locator codes are sent to a command center for further positioning processing to enable data transmission to at least the control server 24. In an embodiment, the command center is control server 24. In another embodiment, the command center is the intelligent component representing at least a control module 20, computer 16, telephone, television, etc.

at mode 09, the locator codes are matched to an environment representing various levels of the home. The environment can be a specific floor, hallway, corridor, balcony, room, or the like monitored with sensors. The environment can further be a specific area within a floor, hallway, corridor, balcony, room, or the like and being watched by interactive detector 122. The environment can also be a specific area within an external perimeter of the offices and residence hosting system 10, or an adjoining or at least a standing shelter on the residential, commercial/industrial grounds.

At mode 12, the current environment is communicated to the intelligent component and/or stored in the records of control server 24 for future recall. After the system component has been positioned and its positioning data has been updated, the control flow ends as indicated at mode 13.

In an embodiment, the positioning information enables system 10 to command and/or control specific system components based on the current location of a home occupant interacting with system 10. This can be described with reference to FIG. 6. FLOWCHART 200, as illustrated in FIG. 6, represents the general operational flow of an embodiment of the present invention. More specifically, FLOWCHART 200 shows an example of a control flow for commanding and/or controlling system components based on a home occupant's current location. Referring to FIG. 6, the control flow of flowchart 200 begins at MODE 11 and passes through media links to detect data indicative of unwanted objects to enable MODE 03-09. As described with reference to FIG. 5 at MODE 03-09, locator codes enable system 10 to determine the current location or environment of a home occupant upon detection, and enabling the detectors to interactively enable communication with an intelligent component having at least a control module 20.

At MODE 12, an environment profile is accessed for the environment. The environment profile includes a listing of devices having links with distant destination and/or other device applications representing system components that receive commands and/or controls from control server 24 and/or control module 20. At MODE 15, the environment profile is processed to present control options for the home occupant to review. The control options include the listing devices in communication with device destination and/or other device applications corresponding to the environment profile. As described with reference to FIG. 5, the positioning can be determined remotely at control server 24 or locally at the intelligent components such as cell phones, telephones, computers, portable wireless devices, control module 20, and the like. When detection is enabled and determined remotely, control server 24, for example, produces description of the detection through interactive communication with plurality devices having camera means and in wired/wireless communication with the control server 24. The control server 24 sends a home occupant detection data through interface means with at least an intelligent component and enable displaying the detection and control options on the intelligent component such as the control module 20 or another system component that the home occupant is operating. If transmitted data is determined locally, at least the intelligent component retrieves the environment profile data to enable the home occupant to interface with the environments of the home to which detection was enabled and also with security agencies such as the fire department and the police department. The environment profile can be sent to the intelligent component on demand through wired/wireless means, or the intelligent component can be updated periodically with available environment data.

At mode 18, the home occupant operates the intelligent component such as at least a control module 20 to send a request to control a system component such as television 22, application software 26 and the like that are identified in the environment profile. The home occupant can send a request to control a function and/or an operation of a system component. The home occupant can send a request to alter the configuration or security profile for the component. Other control request can be sent as would be suggested by one skilled in the relevant art. At mode 21, the control request is executed by the designated component such as at least a television 22. The control request can be transmitted directly to the designated component, or indirectly to the designated component via control server 24. After the control request has been executed, the control flow ends as indicated by mode 95.

For example, if a home occupant is operating control module 20 and is determined by system 10 to be positioned in the living room, control module 20 would receive a home occupant interface signal responsive for controlling system components in the living room. One system component can include, for example, security monitor 28 that receives video input from camera 18 located at the television 22, the front door to the offices and residence homes, or embedded in the interactive detector 122 devices positioned in the various environments of the homes. The home occupant can interact with control module 20 to pan, tilt, or focus camera 18 on the television to display an image on television monitor 28, other monitors and hand held devices to display images of intruders standing at the front door or hiding inside the house. Another system component can be television 22 in communication with the control module 20 for receiving home occupant interface signal and responsive for controlling the activation of interactive detector 122, the alarm volume levels for the detectors, and/or channel selections for enabling detection images to be transmitted through the television 22 to the control server 24.

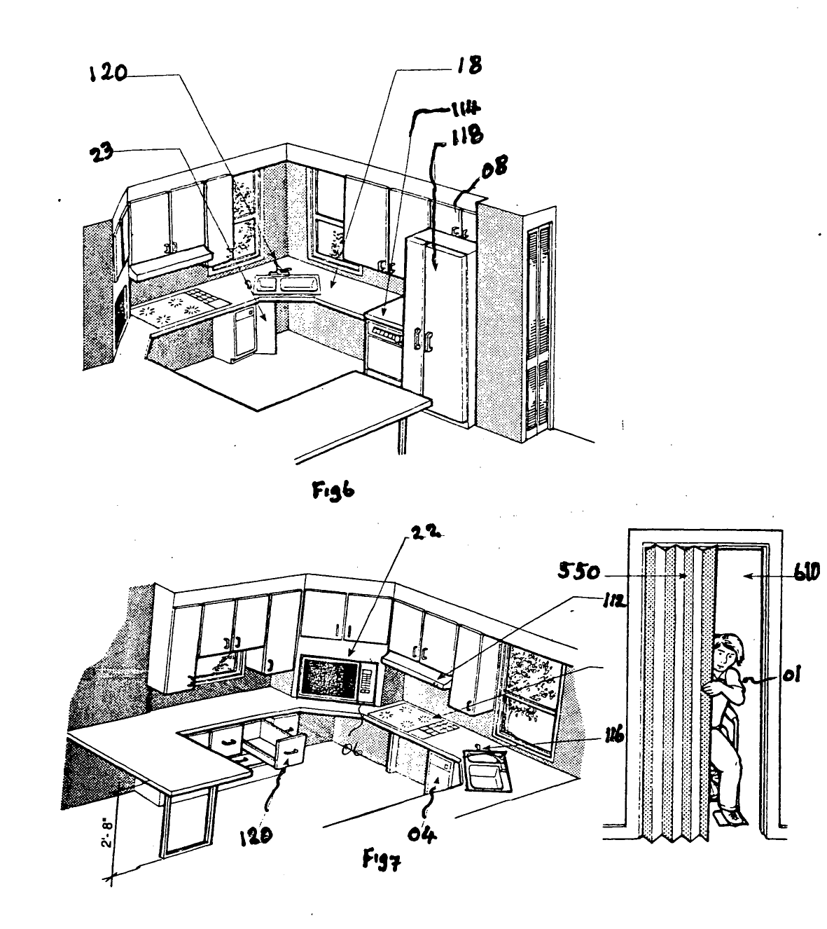

The present invention supports various texts, graphical or verbal command interfaces for presenting the control options to a home occupant. FIG. 7 illustrates an embodiment of a home occupant interface 183 for presenting location-specific control options and for enabling detection data transmission. Home occupant interface 183 is produced on control module 20. However, as described herein, a home occupant can operate any of the other system components to send control demands, provided the system component is configured to produce interactive communication with home occupant interface 183 or the like.

Home occupant interface 183 includes a control options environment 184. Control options environment 184 identifies system components from an environment profile for a designated environment. In this example, the environment is a living room, a kitchen, a dinning room, a bed room, a basement, an office, or the like. System components identified in the environment profile for living room include television 22 and a voice auditory/audio means 118. Component controls 185a-185b enables a home occupant to send control demands to a corresponding system component. Component control 185a corresponds to television 22. Component control 185b corresponds to a voice auditory/audio means 118. Additional component controls 185a-185b can be included to send control demands to other system components profiled for a particular environment.

The environment, specified by control options environment 184, can be determined by the positioning embodiments described above, or the environment can be home occupant-specified regardless of the current location of the home occupant's control module 20. The environment is a home occupant's-specified region by activating the environment interactive detector 122, 121.

Messaging interactive detector 122, 123 enables the home occupant to interact with messaging controller 112 described with reference to FIG. 3. Therefore, the home occupant is able to check detection upon emails communication, voice mails, intra-residential, commercial/industrial messages, or the like.

Media and detected data viewer 210 is linked with the control server 24 and enables the home occupant to view media and detected data from the television and other system components. For example, the home occupant can interact with component control 185a to view a television program that is currently being broadcast on television 2, while the television 22 is also responsive for monitoring the home and for enabling communication when detection is enabled. That is, nano sensors are embedded inside the television 22, and the nano sensors enable interactive communication with the video camera embedded inside the television for enabling detected image transmission. The home occupant can also interact with component control 185b to receive audio from a voice auditory/audio means 118.

Although media and detected data viewer 210 is shown as a video or multimedia and detected data distributor, media and detected data viewer 210 also allows audio signals to be received without video. Media and detected data viewer 210 can also be a web browser, or software application for word processing, video games, or the like. Therefore, the home occupant can interact with control options environment 184 and other environments configured with interactive detectors 122, 121 to receive text, audio, video, or media and detected data and/or multimedia and detected data from other system components from any location within the residential, commercial/industrial environment hosting system 10.

The present invention further enables a home occupant to operate control module 20 to command and/or control other system components. In an embodiment, control module 20 only permits the home occupant to control system components within the vicinity of control module 20 environments. In another embodiment, control module 20 provides the option of controlling system components in another environment.

In yet another embodiment, the control of the various system components is based on preset data established and assigned to various types of detection for the home occupant and the home. The data can be generic for all home occupants and/or specifically configured specifically for home occupant use. If configured for a specific home and home occupant, the present invention utilizes various protocols to identify or authenticate a specific home occupant and execute the profile established for the home occupant. In another embodiment, a home occupant detection type and/or password is entered into a system component such as control module 20, etc. The password can be expressed by at least a verbal command, text, object, mega-pixel resolution having optical/digital zoom, or the like. In another embodiment, biometrics is collected by a system component. As such, retinal, iris, facial, palm, fingerprint, and/or voice recognition technologies, or the like are implemented to identify and/or authenticate a home occupant. In another embodiment, a home occupant card is read by a system component such as the control module 20. Other home occupant identification and/or authentication techniques can be used to identify and/or authenticate a home occupant. The present invention permits the home occupant to alter the profile, as appropriate. The identification and/or authentication techniques, described above, prevent other home occupants from altering or deleting the home occupant profile after it has been established and/or confirmed.

In still another embodiment, the present invention enables a home occupant to establish a profile to store a favorite setting for the system components. For example, a favorite setting can be established for television programming, audio/video recordings, room temperature control, clock alarms, light/dimmer settings, web sites, news broadcasts, or the like.

In these embodiments, the home occupant can establish a profile to create a checklist. A sequence of graphic images or photographs can be prepared and/or stored for transmission or playback on, for example, monitors 116 or computer 16. A checklist of other forms or media and detected data and/or multimedia and detected data can also be created according to embodiments of the present invention, as would be apparent to one skilled in the relevant art.

In yet another embodiment, a profile can be created to establish a security protocol for the system components. For example, a profile can be created to block certain content from being accessed by non-designated home occupants. Non-adult home occupants, for instance, can be prevented from accessing designated television channels, web sites, areas such as, lockable rooms that store the codes to activate and/or deactivate the detection system.

In the embodiments, the present invention enables a single home occupant to establish multiple data. Each of the multiple data can be tailored for context-sensitive activity. For instance, a home occupant can create a profile for security monitoring while enjoying evening entertainment, and the security monitoring includes without limitation, audio/video detection and presentations to a control server 24, security access warnings from interactive detector 122 or the like. A home occupant can also establish multiple data for use with/or communicated to other individuals. For example, a home occupant can have a profile with security controls set to block certain televisions programming and enable activation of the camera for communications with web sites, audio recordings, or the like when in the company of minors. However, when in the company of adults, the home occupant can recall another profile with more liberal security settings.

As such, the present invention enables various system components through control server 24 and the control module 20 to be home occupant awareness in addition to being location awareness. Thus for example, control module 20 can be customized per home occupant based on the aforementioned home occupant data. In embodiments, the home occupant awareness functionality permits system 10 to implement watch-me system controls. For instance, “watch-me” video is implemented to transfer a selected video detection to various displays throughout the controlled environment. The home occupant would operate, for example, control module 20 to select a video detection captured by the television video, DVD recording, or the like. The video production can be presented on control module 20 e.g., media and detected data viewer 210 described with reference to FIG. 7. As the home occupant migrates from room to room within the controlled environment, system 10 tracks control module 20 and retrieves environment profile for each environment Therefore, as the home occupant enters a new environment or room, monitor 28 or television 22 located in the room will automatically start to display the video production of the occupant selected by control module 20.

Similarly, “watch-me” audio can be implemented by the present invention. As such, the home occupant can operate, for example, control module 20 to select an audio production through CD recording or radio broadcast or the like. As the home occupant migrates from room to room, the positioning techniques of the present invention, which includes body heat sensors as members of the interactive detector 122, enable system 10 to transfer the audio production to the audio/video clients 118, such as the fire department and the police department, enabling the clients 118 to view first hand the situation and magnitude of the environment through monitors 116 or the like that are located in the vicinity of the clients control module 20.

“Watch-me” lighting is another exemplary implementation of the present invention. As a home occupant, positioning or carrying control module 20 to enter or leave a room enables system 10 sends commands enabled based on the profile settings.

In an embodiment, one or more control microprocessor 105 enabling communication is established to control the operations and/or functions of the system components. A control microprocessor 105 includes a set of commands that, when executed, enables control server 24 to control multiple operations and/or functions of one or more system components. The control microprocessor 105 enable set of commands to be associated with detection data storage for future recall and execution.

A home occupant can define control microprocessor 105 operation by operating control module 20, computer 16, or a home occupant interface in communications with control server 24. In an embodiment, a graphical home occupant interface can be implemented to enable a home occupant to define a new control microprocessor 105. FIG. 9 provides an example for defining control microprocessor 105, according to an embodiment of the present invention. Flowchart 900 shows an example of a control flow for defining control microprocessor 105 to watch the entire section or regions of the home and/or office.

Referring to FIG. 9, the control flow of flowchart 400 begins at mode 31. When the home occupant triggers a record-microprocessor 105 command to distinguish the microprocessor 105 communication and recording mode from normal system operations of cameras, detection is enabled at all environment. At mode 33, the home occupant operates one of the aforementioned devices to enable data transmission to other destination such as the client through control module 20, computer 16, interactive detector 122 or a home occupant interface, and through communication with control server 24 indicative of viewing selected room containing and/or having the system component such as television 22, monitor 28, etc. responsive for enabling the home occupant to use the said components to view the detection environment and images.

At mode 36, the environment profile for the selected room is recalled. As discussed above, an environment profile identifies all system components located in a designated environment. In an embodiment, the environment data are stored at control server 24, which retrieves and makes the appropriate environment profile available to the home occupant.

At mode 39, the home occupant reviews the environment profile and selects a viewing system component such as a handheld monitor or a television 22. The home occupant also specifies the video input responsive for enabling a DVD source recording. The home occupant can specify any desired settings, including but not limited to making adjustments such as zoom, contrast, brightness, and the like.

At mode 42, the home occupant specifies the desired audio settings. In an embodiment, the home occupant set the volume level for the alarms and viewing system component such as television 22. In another embodiment, the home occupant selects external speakers for broadcasting when detection is enabled, such as a voice auditory/audio means 118 to be used in addition to, or in lieu of, the internal speakers for the viewing system component.

At mode 45, the home occupant selects the desired device to activate detection devices such as DVD, cable box, interactive detector 122 and the like in communication with the media and detected data recognizer 06. Alternatively, if a DVD distributor such as the media and detected data analyzer 08 are located in the same room with the selected viewing system component such as at least a television 22, the home occupant can instruct media and detected data analyzer 08 to enable activation of detection and image loading.

At mode 51, the control commands for executing the specifications for television 22, a voice auditory/audio means 118 (if selected), media and detected data analyzer 08 (or media and detected data recognizer 06), and lighting application software 26 are collectively associated with control microprocessor 105.

At mode 58, the home occupant saves the control microprocessor 105 and gives it an activation code for enabling detection data, such as “sending images.” In an embodiment using control module 20 to activate microprocessor 105 for “sending image,” communication with the home occupant can associate the microprocessor 105 to a specific microprocessor 105 buttons or icon. Therefore, when the home occupant activates the “sending image” microprocessor 105 button, all of the associated commands for implementing the home occupant's pre-specified selections are recalled and executed, so that television 22 is ready to communicate the desired request to control server 24. After the control microprocessor 105 are activated and data saved, it is then ready for transmission and the control flow ends as indicated at mode 45

In an embodiment, the commands associated with specific control microprocessor 105 are stored at control server 24, or in a database or library affiliated with control server 24 or the media and detected data archive 04. Therefore, in an embodiment using control module 20 to execute a control microprocessor 105, control module 20 enables a home occupant to associate other control microprocessor 105 with a control microprocessor 105 button or icon 106. When executed, the control microprocessor 105 button transmits a generic command to control server 24. Control server 24, in turn, retrieves the set of commands associated with the generic command, and transmits the set of commands to the appropriate system components for execution. In other words, the present invention enables a mobile device, such as control module 20, to transmit a single high-level request to a centralized command center, such as control server 24. Control server 24 interprets the single request according to its environment such as the home, rooms, and location of other rooms to find the corresponding sequence of commands that needs to be transmitted over communications network 80 and/or Internet, which includes wireless or power-line communications.

Alternatively, according to an embodiment of the present invention, the control microprocessor 105 is enabled automatically by the control server 24 based on the particular devices in which they are implemented on, or the destination means or existing interactive detector 122 in a selected room or environment. These devices are either known by the control server through stored room data or as detected in real time by the control server 24 as the room profile is created. For example, if the control server 24 detects that a room such as the living room has a DVD distributor and a TV, the control server will automatically build a basic communication with “security watch” microprocessor 105 comparable to the microprocessor 105 described above, which can be further customized by the home occupant.

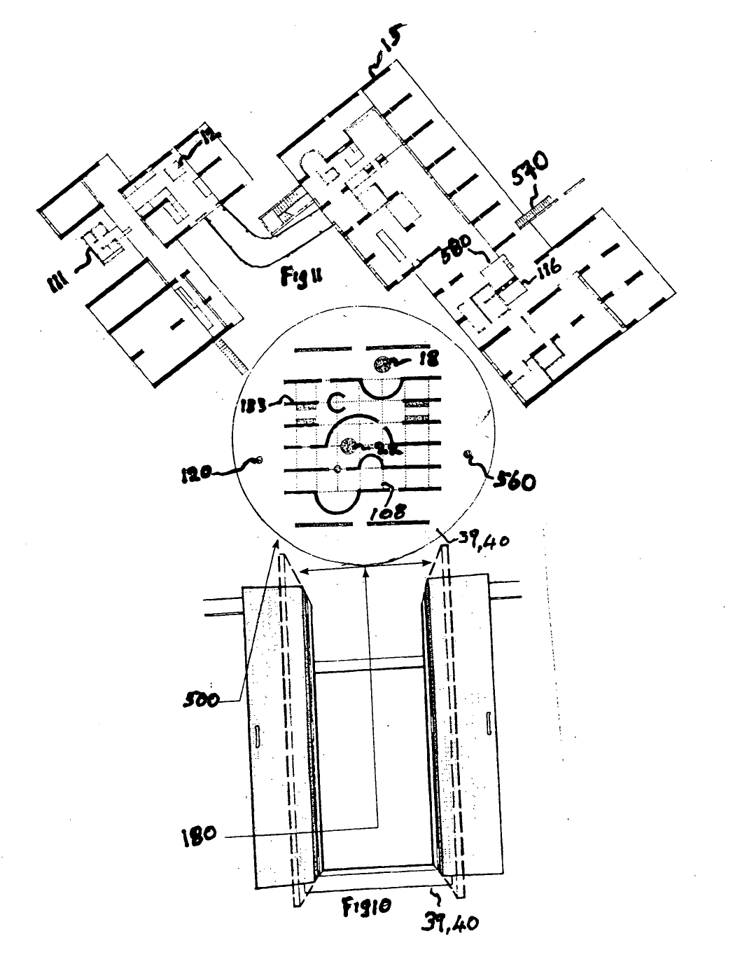

FIG. 10 illustrates an example for activating the control microprocessor 105 according to an embodiment of the present invention. Flowchart 1000 shows a control flow for activating the control microprocessor 105 of flowchart 900, which pertains to enabling security monitoring while watching a movie or enabling recording on a TV, DVD, etc.

Referring to FIG. 10, the control flow of flowchart 1000 begins at mode 61 and passes immediately to detection mode 63. At mode 63, the home occupant activates the “security watch” for the control microprocessor 105 as defined in mode 41-45.

FIG. 10 is a detailed block diagram of the audio/video (A/V) modulator 80 connected to the audio/video source 49 and television 22 media and detected data components of the interactive detector 122 of FIG. 1. The downstream network signal is enabled on line 200 from the wall plate connector 37 and received at the modulator's coaxial cable connector 201 to enable signal conduction through line 62 to a high pass frequency filter 204. The high pass frequency filter is referred to as RF modulated signal filter, and low pass frequency filters 78. The filters 204, 206 are substantially similar to high pass filters 67, 68 and low pass filters 69, 70 described herein with respect to FIGS. 3, 4, respectively. This high pass filters separate the received RF broadcast television signals and RF modulated video signals onto line 90, and the low frequency signals, including the un-modulated digital signals and electrical command signals, onto line 110.

The downstream broadcast signals on line 90 are presented through a BALUM 212 through line 114 to the A/V modulator's media and detected data signal output 216. The media and detected data signal output is connected by a coaxial cable 217 to the television 22. This media and detected data signal is presented on lines 90 back through the high pass frequency filter 204 to the coaxial connector 201 and to the control module 22, as seen in FIG. 1.

The downstream low frequency digital signals from the low pass filters 78 on line 10 are separated by low pass filters 79 and high pass filter 238 respectively. The signal is then transmitted into 0-2.5 MHz data and information band signal on line 14 and the 2.5-5.0 MHz command and control band signal onto lines 8.

The low pass and high pass filters 236, 238 are substantially identical to the low pass and high pass filters 140, 142 of the Control server signal modulator 24B, which are shown in preferred embodiments in FIGS. 6, 7. As stated herein with respect to the Control server signal modulator of FIG. 5, these are serial digital bit signals transmitted in serial digital form, without signal modulation, and they are transmitted through the network conductors in shared mode with the RF broadcast services signals. In a best mode embodiment the signal bit speed is substantially APPROXIMATE to 1.0 Mbps.

The A/V modulator 80 processes the network 2.5-5.0 MHz command and control band signals, i.e., the IR band in substantially the same manner as the Control server signal modulator 24B of FIG. 5. As with the modulator/demodulator 188 of FIG. 5, the modulator/demodulator 140 frequency modulates the converted signal content at a preferred modulation frequency of substantially 3.0 Mhz. As stated herein, the modulation frequency may be any selected frequency within the command and control band 8.25-5.0 Mhz.

The modulated IR signal is presented through line 142 and back flowed through filters 68 to the line 6, where it is combined with the upstream data and information band signal from the filter 236. The combined low frequency signals are then back flowed through filters 78 to the coax connector 201 and combined with the RF modulated media and detected data signals and coupled through the communication port 134 as seen in FIG. 1, configured with control module 20. The downstream command and control band signal is passed through low pass filters 78 and high pass filters 68 to the modulator/demodulator 140, which demodulates the signal and in communication with the IR/IrDA bridge device 148. The bridge then reformats the payload into an IR frame format and in communication with the IR emitter portion 176, 180 as seen in FIG. 6 A, 6B of the IR emitter-detector combination transceiver 244. The IR emitter broadcasts the signal into the rooms, the home occupant's PC, and the security agencies PC's. This includes the CATV and other broadcast source signals received at the control module connector 42 from line 1 shown in FIG. 1.

As shown in FIG. 11, each of the network ports is coupled through associated control module impedance matching networks 270-274, each connected between the control module signal bus 78A and the individual output ports 24-28. This signal path length is preferably less than a quarter wavelength of the network's highest frequency signal to prevent signal reflections occurring at an un-terminated port at the network's highest operating frequencies. These reflections may cause signal interference with both the broadband and broadcasting signal frequencies. In the present embodiment, with the CATV broadcast signal frequencies approaching 1 Gigahertz or at or about 900 Mhz, the quarter wavelength of a 1 Ghz signal is approximately 1.3 inches.

At mode 66, the set of commands associated with the “security watch” control microprocessor 105 is recalled from other storage locations. The set of commands includes the home occupant-predefined specifications for controlling the functions and/or operations of the specified system components. In this example, the set of commands associated with the “security watch” control microprocessor 105 include commands for altering application software 26 and responsive for activating media and detected data recognizer 06 and/or media and detected data analyzer 08, configured with television 22. If the home occupant desires to listen to movie on a home stereo speaker system, the set of commands would also include commands for activating the appropriate audio system component such as a voice auditory/audio means 118.

In an embodiment using control module 20 to activate the control microprocessor 105, the enabled control module 20 transmits a generic command that is associated with the “security watch” control microprocessor 105. The generic command is sent to control server 24, which recalls the set of commands associated with the generic command for the “security watch” control microprocessor 105.

At mode 69, the room and system components such as television 22, media and detected data recognizer 06 or media and detected data analyzer 08, lighting application software 26, a voice auditory/audio means 118 are identified from the set of commands. In the example described with reference to FIG. 9, the room is specified in the control microprocessor 105. In another embodiment, the control microprocessor 105, itself, does not need to be room specific. As discussed above, the present invention includes methodologies and/or techniques for tracking the location of a home occupant during an emergency and includes a controller device. Therefore, the home occupant can request to activate control microprocessor such as the “security watch” control microprocessor 105 to watch or enable security in any room of the home occupant residence. As such, control server 24 would designate the home occupant's current location as being the room for implementing the control microprocessor 105. Likewise, control server 24 can retrieve the room profile for the home occupant's current location, including the room temperature, and identify the viewing components, media and detected data distributor, and lighting components that are located in the designated room.

At mode 72, a device for accessing permission is validated for each system component identified at mode 69. As discussed above, restrictions on operating various system components can be established and policed by security controller 116, while in communication with other security agencies. Accordingly, the present invention provides methodologies and/or techniques for identifying or authenticating the home occupant that is requesting the “security watch” control microprocessor 105, as well as for determining if the home occupant is authorized to operate the system components designated in the control microprocessor 105. If the home occupant is determined to lack authorization for accessing the designated system components, a message can be sent to inform the home occupant that the access point has been blocked indicative.

At mode 75, the present invention determines which commands are associated with each system component identified at mode 69. For example, the control commands for specifying the viewer settings are queued for television 22. In an embodiment, control server 24 apportions the component-specific commands for each system component. The component-specific commands are encoded and sent to the designated system component via the appropriate protocol. Control server 24 also updates its records for tracking the state of each system component or the home state of emergency.

At mode 68, each system component receives and executes the component-specific commands. As such, the application software 26 enables interactive communication with detectors in the specified rooms and with the specified television 22 turned-on and configured as predefined, and the specified DVD distributor in communication with media and detected data recognizer 06 or media and detected data analyzer 08. Depending on the speaker options specified in the control microprocessor 105, audio 118 is also activated and waits to receive audio feed from the other components or interactive detector 122. At mode 61, a control screen is sent to the home occupant interface unit to activate the control microprocessor 105. If control module 20 is used, the control screen is presented on the display to designate that the control microprocessor 105 and ensure that the control microprocessor 105 have been properly executed and other interactive devices are ready to commence monitoring, detecting, and communicating, if this option is selected. Afterwards, the control flow ends as indicated at mode 75.

FIGS. 1-7 are illustrations allowing an explanation of the present invention. It should be understood that embodiments of the present invention could be implemented in hardware, firmware, software, or a combination thereof. In such an embodiment, the various components and mode would be implemented in hardware, firmware, and/or software to perform the functions of the present invention. That is, the same piece of hardware, firmware, or module of software could perform one or more of the illustrated blocks such as components or mode to enable security watch.

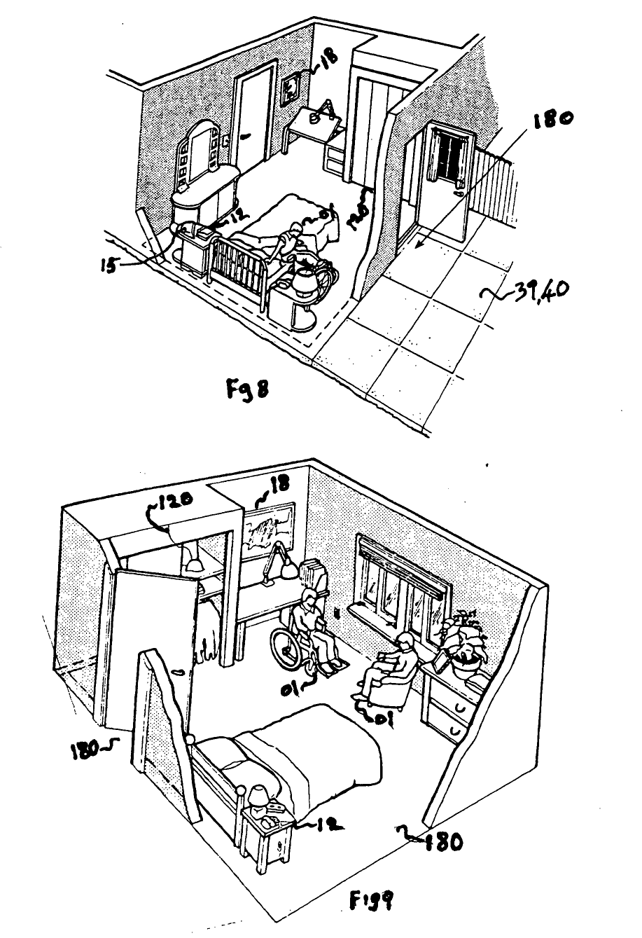

Additionally, the present invention can be implemented in one or more computer systems in communication with detectors, interactive detector 122, cable boxes for enabling security watch, or other processing systems, capable of carrying out the functionality described herein. Referring to FIG. 8, an example computer system 16 useful in implementing the present invention is shown. Various embodiments are described in terms of this exemplary computer system 16. The description makes it apparent to a person skilled in the relevant art to implement the invention using other computer systems and/or computer architectures. The computer system 16 includes at least one or more processors, such as processor 56 and or processor 105. Processor 56 can be a special purpose or general purposes digital signal processor. The processor 56 is connected to a communication infrastructure 57 such as a communication bus, crossover bar, or network.

The control server 24 can represent a computer system 16, which further include a display interface 49 that forwards graphics, text, and other data from the communication infrastructure 57 or from a frame buffer responsive for enabling display on the display unit 830. Computer system 16 also includes at least a primary memory 200,220, preferably random access memory 200 “RAM”, and at least a secondary memory 200,230. The secondary memory 200,230 includes a hard disk drive 64 and/or a removable storage drive 221 representing at least a floppy disk drive, a magnetic tape drive, an optical disk drive, a zip drive, responsive for storing and retrieving detection data and for enabling transmitting all detected data to at least an input source for reviewing detection selection. The removable storage drive 221 reads from and/or writes to a removable storage unit 231 in a well-known manner. Removable storage unit 231 represents a floppy disk, magnetic tape, optical disk, etc. which is read by and written to removable storage drive 221. As will be appreciated, the removable storage unit 231 includes a computer usable storage medium having stored therein computer software such as programs or other instructions and/or data for enabling effective security watch, detection, and communication within at least a localized vicinity.

In an alternative embodiment, secondary memory 200,230 includes other similar means for allowing programmed interactive high definition television programs or other instructions to be loaded into computer system 16. Such means include, for example, a removable storage unit 232 and an interface 233. Examples of such means include a program cartridge and cartridge interface such as that found in video games and other devices, for enabling security watch to destinations internal to the locations of the interactive detector 122. A removable memory 200 chips such as, an EPROM or PROM) is seen associated to at least a socket and other removable storage units 232 and interfaces 233, which allow software and data to be transferred from the removable storage unit 232 to computer system 16.

Computer system 16 can also include communications interface 61. Communications interface 61 allows software and/or data to be transferred between computer system 16 and external devices. Examples of communications interface 61 include a wired/wireless modem, a network interface such as an Ethernet card, a communications port, a PCMCIA slot and card, etc. Software and data transferred via communications interface 61 are in the form of signals 62, which can be transmitted through electronic means, electromagnetic means, optical or other signals transmission means capable of being received by communications interface 61. These signals 62 are provided to communications interface 61 via a communications path such as TV channels 63. Communications path 63 carries signals 62 and can be implemented using wired/wireless or cable, fiber optics, a phone line, a cellular phone link, an RF link, free-space optics, and other communications channels.

In this document, the terms “programmed interactive high definition television medium” and “computer usable medium” are used to generally refer to security media and detected data transmission to devices such as removable storage unit 231, removable storage unit 232, a hard disk installed in hard disk drive 64, and signals 62. These programmed interactive high definition television products are means for providing software to computer system 16. The invention, in an embodiment, is directed to such programmed interactive high definition television products responsive for enabling security watch and for enabling data transmission to at least a device responsive for enabling Internet communication.

Programmed interactive high definition televisions, also called computer control logic or computer readable program, are in communication with detection coding means stored in main memory 200,220 and/or secondary memory 200,230. Programmed interactive high definition television also receives detection and communication signals via communications interface 61. Such programmed interactive high definition televisions, when executed, enable the computer system 16 to implement the present invention as discussed herein. In particular, the programmed interactive high definition television, upon execution, enables the processor 56 to implement the processes of monitoring and detecting at least a foreign object. The monitoring and detection methods are implemented using residential, commercial/industrial control server 24, control module 20, computer 16, and/or other system components for system 10 as described above, such as methods 500 and/or 600. Accordingly, the programmed interactive high definition television represents controllers for the server and computer system 16.

In an embodiment where the invention is implemented using software, the software can be stored in a programmed interactive high definition television product and/or loaded into computer system 16 using removable storage drives 221, hard drive 64 or communications interface 61. The control logic is at least a software responsive for controlling the interactive detector 122 and other elements of the present invention. The control logic, upon execution by the processor 56, causes the processor 56 to perform the functions of monitoring, detecting, communicating, and transmitting detection data as described herein.

In another embodiment, the invention is implemented primarily using hardware, for example, hardware components such as application specific integrated circuits (ASICs) is an implementation of the hardware state machine responsive for performing the functions described herein for enabling security monitoring, detection, and communication. In yet another embodiment, the invention is implemented using a combination of both hardware and software.

While various embodiments of the present invention have been described above, it should be understood that they have been presented by way of example, and not limitation. It will be apparent to persons skilled in the relevant art that various changes in form and detail can be made therein without departing from the spirit and scope of the present invention. As previously discussed, it should be understood that the method, system, and programmed interactive high definition television product for security monitoring, detection, and communication as per the present invention should not be limited to residential, commercial/industrial environment. The present invention is implemented in other types of environments having a central processing system such as the control server 24, responsive for enabling distribution of media and detected data and for sending command and/or control signals to plurality of devices in various destination and/or applications dispersed throughout a designated environment. In addition to offices and residences, the designated environment includes, but is not limited to, homes, apartment, office complexes, suite of small offices, production studios, warehouses, entertainment arenas, health care facilities, hotels, vacation resorts, or the like.

The present invention discloses interactive high definition television for enabling security monitoring, detection, and signal distribution through a control server 24, which provides plurality location for image transfer, telephone/audio communication, and security video application for entrances and other distribution throughout the home, in communication with the control server 24. Input services provided to each of connectors 44, 42 are electrically connected to module connectors 45, 52, 54 positioned within a central environment 53. Each module connector 44, 52, 54 is also electrically connected to a respective output connector 46, 48, 50. The module receiving section 47 corresponds with the module connector 45 and the output connector 46. Likewise, the module receiving section 49 corresponds with the module connector 52 and the output connector 48. The data line module 70 has a circuit board 74 positioned within a housing 78. This data module 70 is electrically configured to pass detection data signals from the first input connector 42 through the module connector 45, to the mating connector 72, and to the receptacle 73. The telephone line module 80 is configured to pass a selected detection through a telephone line to enable signal transfer from the input connectors 44, 42 through a selected module connector 45, 52, 54 to a selected output connector 46, 48, 50. The video module 106 is configured like the data line module 70 configured to pass a selected detection images through the video line from the input connector 44 to a module connector 45, 52, 54, and/or through the mating connector 72 and then to the electrical connectors 001 positioned on the front face 000 of the module 106. These electrical connectors 001 are preferably RCA jack type connectors. Other suitable connectors for passing video signals could alternatively be utilized on the front face 000 of the video module 106. The video module is configured to convert and/or transmit detected objects through video signals and therefore may include active components comprising tuner circuits, filtering circuits, or other video circuits. The video signal is received at the input connector from one of the connectors 001 on the front face 000 of the video module 106 within the distribution panel 400. Second output connectors 002 serve to connect detection output 106 to cables within the distribution network to rooms in the monitoring premises. Video signals may flow bidirectional through the circuit arrangement. Data distribution through the premises may be accomplished by utilizing unshielded twisted pair cable, coaxial cable or other suitable video signal conductors. Additionally, a data distribution panel 200 is similarly joined to the distribution panel 400. The detection data distribution panel 200 is preferably a hub or other suitable data distribution device for enabling a data network. The data distribution device is connectable to the receptacle 73 of a data line module 70 to facilitate bidirectional data communications between the data service input at a hub or other suitable data distribution device and the rooms of the promises. This circuit extends first from the hub then through the cable to a desired data line module 70, then through a selected module connector 45, 52, and 54 to a selected output connector 46, 48, 50.

Electronic image sensors are embedded in the interactive detector 122, the interactive TV, DVD system, cable box system, computer system, at least an entertainment device and the like, and typically comprised of mega-pixel resolution with optical/digital zoom arrays of a large number of very small light detectors, together called “mega-pixel resolution with optical/digital zoom arrays”. Electronic cameras comprise imaging components to produce an optical image of an emergency scene onto the mega-pixel resolution with optical/digital zoom array. The electronic image sensors convert the optical image detected into a set of electronic signals. The most popular electronic image sensors utilize arrays of CCD detectors for converting light into electrical signals. CMOS sensors have multiple transistors within each mega-pixel resolution with optical/digital zoom. In addition to circuitry associated with each mega-pixel resolution with optical/digital zoom cell, CMOS sensors have other digital and analog signal processing circuitry, such as sample-and-hold amplifiers, analog-to-digital converters and digital signal processing logic circuitry, all integrated as a monolithic device for enabling object detection.

In a preferred embodiment the sensor is a 0.3 mega-pixel resolution with optical/digital zoom of 3.2 mm.times.2.4 mm, 640.times.480 array of 5-micron square mega-pixel resolution with optical/digital zooms, which is compatible with a lens of 1/4.5 inch optical format. In another preferred embodiments all of the camera circuits are incorporated on or in a single crystalline substrate along with the sensor mega-pixel resolution with optical/digital zoom circuits.

FIG. 3A is a partial cross-sectional diagram illustrating mega-pixel resolution with optical/digital zoom cell isolation for detection architecture designed for at least five mega-pixel resolutions with optical/digital zooms including sensors array utilizing principals of detection for the present invention.

The detectors further comprises interactive television and the interactive detector 122 configured with at least a single Chip Camera with Photo-isolation means in conduction with the Active Mega-pixel resolution having optical/digital zoom means. Sensor A seen in the preferred embodiment of the present invention is a single chip camera with a photocell sensor, including photo-isolation means consisting of a photodiode array. The photodiode array 600 consisting of photoconductive layers 610 on top of an active array of CMOS circuits 620 is responsive for enabling monitoring, sensing, detecting, and communicating. The sensor section is implemented with a photoconductor on active mega-pixel resolution with optical/digital zoom array having readout circuitry, readout timing/control circuitry, sensor timing/control circuitry and analog-to-digital conversion circuitry. The sensor includes:

(a) a CMOS-based mega-pixel resolution with optical/digital zoom array comprising at least 640.times.480 charge collectors and 640.times.480 CMOS mega-pixel resolution with optical/digital zoom circuits. In other preferred embodiment, as shown in FIG. 2 additional MOS or CMOS circuits for converting the charges into electrical signal responsive for amplifying the signals, and for converting analog signal into digital signal and also for enabling digital signal processing, which are provided on the same crystalline substrate configured with embedded detection sensors utilized for the collection of the charges. The data out of the sensor section 100 is in digital form and with a mega-pixel resolution with optical/digital zoom-sequential stream for imaging object reflectance within the monitoring environment.

(b) CMOS readout circuit in connection with the sensors and interactive detector 122. The sensors include the mega-pixel resolution with optical/digital zoom array 300 and readout and timing/control circuitry 104. FIG. 3A is a drawing showing the layered structure of a 5 mega-pixel resolution having optical/digital zoom section of the mega-pixel resolution with optical/digital zoom array. Two of the four mega-pixel resolutions with optical/digital zooms are coated with color filters of peak transmission with at least 550 nm. They are referred as “Green mega-pixel resolution with optical/digital zooms”. One mega-pixel resolution with optical/digital zoom is coated with color filter with peak at 450 nm “Blue mega-pixel resolution with optical/digital zoom” and one with filter peaked at 630 nm “Red mega-pixel resolution with optical/digital zoom.” Just below the electrodes 116 are CMOS mega-pixel resolution with optical/digital zoom circuits 118. The components of mega-pixel resolution with optical/digital zoom circuits 118 are described by reference to FIG. 3B. The CMOS mega-pixel resolution with optical/digital zoom circuits 118 utilizes at least three transistors 310,312 and 314. Mega-pixel resolution with optical/digital zoom circuit 118 in connection with the interactive television includes collection electrode 306, collection capacitor 308, source follower buffer 316, selection transistor 314, and reset transistor 310 for enabling monitoring, sensing, detecting, and for enabling communication.

(c). The control signals and parameters provided to the imaging object reflectance spectrum enables the image manipulation circuits 106b to make certain corrective changes to the image data before outputting the data from the camera. The image manipulation circuits 106b receive the image data from the environmental analyzer and, with consideration to the control signals received from the control module, provides an output image data signal in which the image data is optimized to parameters based on the control algorithm. In these circuits, mega-pixel resolution with optical/digital zoom-by-mega-pixel resolution with optical/digital zoom image data is processed so that each mega-pixel resolution with optical/digital zoom is represented by three color-primaries. The image manipulation circuits 630 provide color interpolation among each mega-pixel resolution with optical/digital zoom and adjacent mega-pixel resolution with optical/digital zooms with color filters of the same kind so that each mega-pixel resolution with optical/digital zoom can be represented by three color components.

Input and output interface circuits 183 receive data from the communication protocol circuits 146 and convert them into electrical signals that can be detected and recognized by the down-stream device. Since the sensor signal is directly proportionate to the light sensed in each mega-pixel resolution with optical/digital zoom, one can calibrate the camera to configure to a nominal signal under desirable light. To bring the electrical signal back to nominal level, the mega-pixel resolution with optical/digital zoom exposure time to light and/or the signal amplification factor in sensor output enables the image manipulation module to be automatically adjusted. Since the sensor has mega-pixel resolution with optical/digital zooms covered with primary color filters, one can then determine the relative intensity of the light source from the image data. In an embodiment of the present invention, the number of mega-pixel resolution with optical/digital zooms could be increased or decreased from 0.3 mega-pixel resolution with optical/digital zooms almost without limit.

The present invention further relates to detection signal networks, and more particularly to detection signal networks for interconnecting multi-media and detection devices with home occupants and security agencies. The current CE-Bus Standard installation guide for home networks specifies installation of a central distribution box such as control server 24, which receives all of the detection network signals and enables connection with the home occupant and other security agencies both internal and external. External signals include radio frequency (RF) broadband signals from at least CATV, satellite dishes, cable signals, and antenna for receiving broadcast signals such as RF broadcast signals, as well as DOCSIS. The internal signals include signals from the networked components configured with the interactive detector 122, including digital signals from digital signal devices, such as interactive detector 122, control server 24, computers, computer peripheral equipment, telephones and facsimile machines, as well as RF modulated video signals produced by RF modulation of audio/video output signals from the networked multimedia and detected data A/V equipment such as at least the interactive television.

The network signals also include upstream signal transmission such as the RF modulated A/V signals from the network multimedia and detected data equipment which the interface devices, destination communication devices provide over CATV channel frequencies for internal use. The Downstream coax signals include both RF broadcast signals, control signals, and the home occupant RF modulated A/V signals. The broadcasting, digital signal devices, destination devices, including computers, modems, faxes and digital telephones communicate over the twisted pair. Signal splitters 640 are used to divide the source for CATV signal among the cables thereby providing the source CATV signal with substantially constant load impedance, while also providing signal isolation between its output ports to prevent signals propagating from the source connection from being cross coupled to the other output ports. Still another object of the present invention is to provide a network capable of providing bi-directional detection signal transmission of broadband, broadcasting and interactive-infrared signals over at least a single conductor coaxial cable.

According to the embodiment of the present invention, a network includes one or more single conductor coaxial cables routed within proximity to one or more local detectors forming groups of interactive network components of the interactive detector 122. Interface devices are associated with each network components of the interactive detector 122. The interface devices uses frequency division to separate the computer and media and detected data signals from the local group components in communication with the interactive detector 122 for enabling signals into broadcasting and broadband signal frequency channels within a local coaxial cable for distribution. The coaxial cable couples the signals to central control module devices such as at least a control server 24. The control module or devices further receives RF broadcast television signals which it mixes with monitoring and detection signals into the broadband signal channel of each local cable. Additionally, the present invention is responsive for making the RF broadcast signals available to each networked components of the interactive detector 122 concurrently with the broadcasting and broadband signals from each other components of the interactive detector 122 to enable detection and communication signal effectiveness.

In still the embodiment of the present invention, each interface devices includes bi-directional frequency filters for exchanging the computer and media and detected data signals from the components of the interactive detector 122 with the signals from the broadcasting and broadband signal channels of the local cable and telephone system. In a still further embodiment of the present invention, the control module devices includes signal bus for cross coupling the broadcasting and broadband signals among the local cables and telephone utilized for enabling detection communication thereon. The bus has a signal path geometry, which minimizes signal interference within the broadcasting and broadband frequency channels due to signal reflections occurring within the networks.

The invention further includes the use of a novel detection signal control module “NDSCM” 650, which interconnects the individual coaxial cables to the CATV signal source connection without the use of detection signal splitters or detection signal combiners. The network incorporates a multi-master approach with respect to the networked components of the interactive detector 122, including the interactive detector 122 having sensory platform configured with camera means for detection. The network requires that the control server 24 provides for interactive detector 122 signal speeds of at least 1.0 Mbps, a 125 Kbps signal speed for infrared control, and up to 160 television channels responsive for enabling intercommunication within the system. As shown, the network 20 includes a control module 22, which receives network signals at plurality of network signal terminals 24-28. Each network terminal is connected to one of a plurality of electrical signal conductors 30-33 comprising the network's communication port. The communication port is the network's means for exchanging network signals between the control module 22 and the components of the interactive detector 122 at locations 38-41. The control module 22 also receives, at broadcast signal input 42, broadcast signals, such as television programming signals. The signals are either in broadband digital signals and/or analog signals, received in a radio frequency (RF) modulated signal format on line 2 from broadcast signal sources, such as CATV services, or configured with antenna to receive broadcasts, and/or broadcast satellite services.

One novel aspect of the present invention and the network is the shared modes transmission of low frequency digital signals in the range of at least 0-5 MHz band with RF broadcast services signals above the range of at least 5 MHz through common coaxial conductors. Each individual coaxial conductor 30-33 supports bi-directional network signal transmission through simultaneous upstream network signals output from components of the interactive detector 122 to control module 22, and the downstream network signals output from control module to components of the interactive detector 122. As described in the embodiment, data and information band signals (0-2.5 MHz) are transmitted at signal speeds of at least 1.0 Mbps. The command and control band signals are transmitted at signal speeds of at least 125 Kbps.

The upstream network signals are received by the control module and are separated by the control server 24 into low frequency (0-5 MHz) digital signals. The digital signals are coupled to the detection and communication means through the low pass filters 69, 70 and/or the low frequency bus 71. The high frequency (>5.0 MHz) RF signals are coupled to the detection and communication means through the high pass filters 67, 68 to the BALUMS 80, 92. The broadcast signals are combined with the media means to enable detection data signals in forming the downstream network signal. Since the low frequency and high frequency signal transmissions are independent of each other, the low pass frequency filters provide a direct bypass between the control module terminals 24-28 (FIG. 1) to maintain digital signal speed.

The low frequency digital signal bands (0-5.0 MHz) and the high frequency RF signal bands (>5.0 MHz) require different interface devices between other respective type components of the interactive detector 122 and the network. The computer components in communication with the interactive detector 122 interface with the network through a network “Control server signal modulator”, such as the Control server signal modulators 102, 104 as seen in FIG. 1. The media and detected data enabled by components of the interactive detector 122 interfaces with the network through an audio/video modulator, such as the A/V modulators 106-106b as seen in FIG. 1. Each modulator type receives the shared-mode, downstream network signals and separates the low frequency digital signals (0-5.0 MHz) from the high frequency RF signals (above 5.0 MHz), and further separates the detection data and information signal (0-2.5 MHz) from the control and command signal (2.5-5.0 MHz). The command signaling means includes at least a nucroprocessor 105 responsive for transmitting computer signals. Each transmitted signal enable an RF modulator to provide for RF modulation of the media and detected data signals at any of the 16 CATV and 16 UHF terminals. The terminals are responsive for enabling communication with the home occupant and reserved for channel frequencies for network distribution of signals to other components of the interactive detector 122.

Referring to FIG. 5 is a schematic block diagram of Control server signal modulator type devices 102, 104. The downstream network signal is received at a coaxial connector terminal 110 and presented jointly through lines 112 to high pass frequency filter 114 and low pass frequency filter 116. The high pass filter 114 alternately referred to as a RF modulated television video frequency filter, for filtering the downstream RF broadcast television signals and RF modulated video signals onto line 118. The low pass filter 116 segregates the low frequency digital signals onto lines 120.

The filtered RF modulated signals on the line 118 are presented through a BALUM 122, to the Control server signal modulator's video signal output 124. This carrier is amplitude modulated by the received object video signal. With respect to the low frequency digital signals of the downstream network signals passed by filter 75 onto lines 12, low pass filter 76 couples the 0-2.5 MHz data and information frequency band signal onto line 144. The high pass filter 77 couples the 2.5-5.0 MHz command and control frequency band signal onto line 14. The impedance matching network for separating detection source provides an impedance value to signals propagating through filter 76 to the line 13. The signals approximates the characteristic impedance provided by the coaxial cable, thereby providing a substantially balanced load impedance to the un-modulated digital signals propagating in each direction such as at least bi-directionally through the filter 76.

The high pass filter 77, which is also referred to as an electrical command signal filter, is a balanced impedance, double Pi, shunt inductor—series capacitor type filter, as shown in FIG. 6.

As stated in the embodiment of the present invention, the Control server signal modulator facilitates the USB transactions by exchanging packets between the home occupant PC 45 and the network, and the network transmits the packets within its transmission of network signals to each of the other network connected Control server signal modulators. Contrary to the USB requirement for differential output drivers, which require two conductors to send a signal, the network includes a television and uses a single conductor coaxial cable to distribute the detection signal to enable network signals. The network's communication port coax is much longer than 5 meters since it distributes the network signal throughout the house. The processor in turn relays the downstream transaction signal to the PC 45. Conversely, the upstream serial IrLAP digital signals on line 14 from the FET 154 are back-flowed through the low pass frequency filters 75, 77 to the coax connector 110.

As stated in the embodiment containing the network of the present invention, the signal transmission format of the data and information band signals is a serial digital bit signal transmitted in serial digital form, without signal modulation. These non-modulated signals are transmitted through the coaxial conductors in a shared mode with the RF broadcast services signals distributed by ADT, America Security Inc. or the like. In the disclosed network embodiment the signal bit speed is substantially equal to 1.0 Mbps. In the best mode embodiment the low pass filters within the signal transmission path, including the filters 69, 75 and 76 provide sufficient dampening of the digital signal ringing to accommodate higher bit speeds within the 0 to 2.5 MHz band.

The network's 2.5-5.0 MHz command and control band is used to facilitate wireless infrared (IR) signal communications associated with the interactive detector 122 enabling component of the network. Referring back to FIG. 1, the network's wireless IR communications function includes the operator/home occupant's control of the network through a control module connected to components of the interactive detector 122. This is also enabled through an IR remote control device 65, or the home occupant's IR wireless means responsive for enabling transfer of data and/or signal commands between at least an external device such as a lap top computer and network connected PC 45. This is enabled by IR signals emitted in any location serviced by the network and converting the detected IR signal to a modulated signal which is routed to all network locations, and demodulating the distributed signal back to IR for the intelligent components of the interactive detector 122.

The emitted IR signals within a network site, either consumer IR or IrDA protocol, are detected by IR detectors disposed within television, the walls or ceiling of the home, and the Control server signal modulators 102, 104 as seen in FIGS. 1, 4, and/or A/V modulators 106-106b as seen in FIG. 1. Similarly, network emitter responsive for enabling interactive communication with the network IR detectors 192, 194 provides forward field-of-view coverage. The IR/IrDA bridge device 164, exchanges detection data between the IR emitter-detector-123 and the microprocessor 105, 56. The modulator/demodulator or frequency modulates the converted signal content at a selected modulation frequency within the 2.5 to 5.0 Mhz command and control frequency band. The modulated IR signal is back-flowed through filter 146 as well as the low pass filter 116 to the coax connector 110, and transferred in shared mode with the RF broadcast service signals through communication port 134 as seen in FIG. 1, enabling the control module 22 of other modulators connected to the network to stay in communication. The IR emitter broadcasts the signal to devices carried by home occupants and/or security agencies. With a USB PC connected to the network through a Control server signal modulator, the PC video output can be displayed on, and functionally controlled from, any TV in the house. This occurs through home occupant input through the control module 22 to the network, which is configured with remotely controlled devices as seen in FIG. 1. The remotely controlled devices are a combination of wired/wireless infrared (IR) and wired/wireless RF unit, which allows for direct communication between home occupant and the network, connected PC, enabling on-screen-home occupant-friendly interactive/interface technology.

Home occupant actuation of the menu button 660 causes the remote control to substantially simultaneously emit a 916 MHz RF command signal and an IR code signal. In the Control server signal modulator, the RF command signal is forwarded from receiver 19 to microprocessor 105, 134 and, through USB connector 14, to the home occupant's PC 45. The home occupant PC functions as the wireless server for the network, allowing control server 24 to function as the main centralized communication and control device having USB and cable ports. At the same time allowing the network modulator at the home occupant location to enable detection of the remote control IR code signal and notifies the host PC of the home occupant location over the control and command band (2.5-5.0 MHz). The PC is responsive for changing the TV channel at the home occupant location to a PC Menu channel selected from among the reserved RF spectrum channels for outputting detection data.

What is claimed:

1. A method for enabling security vigilant monitoring and communications; comprising:
a control server responsive for distributing detection signals through radio frequency (RF); interactive detectors;
an entertainment device configured with at least a camera means;
said entertainment device enabling security monitoring in communication with at least a control server responsive for distributing signals exchanged between networked appliances;
said exchanged signals including RF modulated video signals from at least said interactive detectors, television camera/detector, cable box detector, entertainment appliances detection, and RF modulated video signal appliances and un-modulated digital signal appliances configured with coaxial cables having cable characteristic impedance for transmitting text and image data, the method further comprising the steps of:
installing at least a device which enables detection and comprises interactive means responsive for communicating with said distribution unit for distributing detection data through wired/wireless means;
said distribution unit comprising signals from plurality devices to enable detection data transmission/distribution to apparatus having a source input for receiving at least the RF modulated broadcast television signals from the broadcast source and having a plurality of signal ports for receiving the RF modulated video signals and un-modulated digital signals from each of the plurality interactive detectors;
coupling the RF broadcast signals from said interactive detectors to within said signal distribution unit, from said source input to each said signal port;
coupling at least the RF modulated video signals and the un-modulated digital signals received at each said signal port wired/wirelessly to each other signal port external to said distribution unit; and
connecting each entertainment appliance having monitoring and detection means to its associated coaxial cable through an associated plurality of signal frequency filters having at least a digital/analog signal frequency filtering means with at least a frequency band-pass suitable for passing through un-modulated digital signals at a selected signal bit speed capable of transporting at least a still image, each said filter being connected at a first terminal to the associated entertainment appliance for enabling communication thereof, each one of said filters providing a substantially equal filter characteristic impedance to band-pass signals propagation for enabling security monitoring and communication with said control server.

2. The method of claim 1, wherein said interactive detector includes at least a high definition Interactive television with embedded camera having MOS or CMOS based active sensor array enabled for producing electronic images during a detection phase and having electron-hole producing light coupled to the pass-band of said RF modulated video signal filter, and wherein said video signal filter is at a higher frequency spectrum than the pass-band of said digital signal filter.

3. The method of claim 2, wherein the sensor array having mega-pixel resolution with optical/digital zoom and includes a layered photodiode for converting the electron-hole producing light into electrical charges in communication with the control server having a central processor for enabling the control of security monitoring and for enabling the distribution of detected data, voice, and other control signals within an environment via a wired and/or wireless communications network.

4. The method of claim 1, wherein said steps for enabling interactive security vigilant monitoring, detection, and communication further includes the steps of:
monitoring and distributing detected signals through radio frequency (RF) modulated television signals from a wired/wireless connection and/or a broadcast signal source to network with components of the interactive detector configured with coaxial cables capable identifying each digital signal source to each associated digital signal frequency filter; and
inserting a filter impedance matching network intermediate to the connection between each digital signal source and said first terminal of said associated digital signal frequency filter, said filter impedance matching network providing a terminating impedance value at said first terminal which approximates the cable characteristic impedance provided to said second terminal, thereby providing substantially equal filter characteristic impedance to un-modulated digital signals exchanged at a signal bit speed appropriate for enabling security monitoring and communication with said control server through said digital signal frequency filter.

5. The method of claim 4, wherein said step for enabling security vigilant monitoring and detection further includes the step of:
enabling the control server to support video/audio serving, telephony, messaging, file sharing, internetworking, and security to allow home occupants to access and control the home network environment during emergency from any location within a controlled residential, commercial/industrial and/or non-residential, commercial/industrial environment, including the surrounding areas, and wherein said network provides impedance matching detection signals as a series resistor functionally connected at a first side detection to said first terminal of said digital signal filter and connected at a second side detection to the digital signal source, said series resistor being further connected at said first and second side through a shunt resistor to the low voltage potential reference of the digital signal source.

6. The method of claim 5, wherein said step for enabling security vigilant monitoring and detection further includes the step of:
embedding a camera in a television for monitoring and providing security assistance to a home, home occupants, and other security agencies;
communicating captured and detection signals to at least a control server for determining at least one intruder and/or one fire-property or characteristic of occupancy of the home constituting information about the security and occupancy state of the home;
control server automatically establishing a communication channel between the home and at least a remote facility without manual intervention to thereby enable the information about the security and occupancy state of the home to be transmitted to the said remote facility;
blocking the RF modulated video signals and un-modulated digital signals received at said control server output signal ports from being coupled to a source input at the remote facility and considering the information about the security and occupancy state of the home received from the home television for central communication device and directing assistance to the home and any of the occupied sections based on the transmitted information;
obtaining images of the various sections of the home and identifying local devices within a vicinity of said source, said local devices comprising plurality of network devices; and
enabling creation of a sequence of commands that, when executed, controls an operation or a function of the plurality of network devices associated with sequence of single command, storing said sequence on a control server for transmitting the images of the various sections after the break-through or at least a detection.

7. The method of claim 6 further comprising the steps of:
storing said single command on a controller device such that execution of said single command sends a request to said control server to execute said sequence of commands for determining when the home experiences a break-through and for obtaining images of the various sections of the home; and
transmitting the images of the various sections to at least a remote facility prior to the break-through.

8. A method for enabling security vigilant monitoring and communication comprising:
a control server responsive for distributing detection signals through radio frequency (RF);
an entertainment device configured with at least a camera means responsive for distributing signals from a broadcast signal source to network appliances forming a complete network comprised of single conductor coaxial cables interconnected through a distribution unit;
said distribution unit and said entertainment device simultaneously therewith enabling security monitoring and communication with the control server configured for distributing signals exchanged between the networked appliances over the same coaxial cables throughout the complete network;
said exchanged signals including RF modulated video signals from at least interactive detectors, television camera/detector, cable box detector, entertainment appliances detection, and RF modulated video signal appliances and un-modulated digital signal appliances, wherein the coaxial cables having cable characteristic impedance for transmitting text and image data, the method further comprising the steps of:
installing at least a device which enables detection and comprises interactive means responsive for communicating with a distribution unit for distributing detection data through wired/wireless means;
configuring said control server and said distribution unit comprising signals from plurality detection and monitoring devices to enable detection data transmission/distribution to apparatus having a source input for receiving at least the RF modulated broadcast television signals from the broadcast source and having plurality of signal ports for receiving the RF modulated video signals and un-modulated digital signals from each of the plurality interactive detectors;
coupling the RF broadcast signals from said interactive detectors to within said signal distribution apparatus to each said signal port representation of at least a detection data type;
coupling at least the RF modulated video signals and the un-modulated digital signals received at each said signal port wired/wirelessly to each other signal port external to said distribution unit;
connecting each appliance having monitoring and detection means to its associated coaxial cable through an associated plurality of signal frequency filters having at least a digital/analog signal frequency filtering means with at least a frequency band capable of transporting at least a still image, and configured with at least a video signal filter having a frequency band-pass suitable for enabling security monitoring and communication with a control server responsive for video data and detection caption in communication with an external device;
determining at least one fire-property or characteristic of occupancy of the home constituting information about the security and occupancy state of the home;
automatically establishing a communication channel between the home television device, the control server, and a remote facility without manual intervention to thereby enable the information about the security and occupancy state of the home to be transmitted to the remote facility;
at the remote facility, considering the information about the security and the occupancy state of the home received from the home and directing assistance to the home based on the transmitted information; and
the step of determining at least one fire-property or characteristic of an emergency and the occupancy state of the home comprising the step of determining any motion in the various sections of the home, whereby information about any motion of occupants in the various sections is transmitted as part of the information about the security and the occupancy state of the home.

9. The method of claim 8, wherein the step of determining at least one fire-property or characteristic of occupancy of the home comprises the step of determining the number of occupants in the various sections of the home as part of the information about the security and occupancy state of the home.

10. A method for monitoring and providing security assistance to a home and home occupants, comprising the steps of:
determining at least one fire-property or characteristics of occupancy of the home constituting information about the security and occupancy state of the home; automatically establishing a communication channel between the home and a remote facility without manual intervention to thereby enable the information about the security and the occupancy state of the home to be transmitted to the remote facility;
at the remote facility, considering the information about the security and the occupancy state of the home received from the home and directing assistance to the home based on the transmitted information;
the step of determining at least one fire-property or characteristic of emergency and the occupancy state of the home comprising the step of determining the number of occupants in the various sections, the number of occupants in the various sections being transmitted as part of the information about the occupancy state of the home; and
wherein the step of determining the number of occupants in the home comprising the steps of receiving waves energy or radiation from all of the each locations in the various sections and determining the number of occupants in the various sections from the received waves, energy or radiation, the number of occupants in the various sections being transmitted as part of the information about the security and the occupancy state of the home.

11. The method of claim 10, wherein the step of determining the number of occupants in the home comprises the step of arranging at least one heartbeat sensor and at least one body heat sensor in the home to detect the presence of human heartbeats in the home such that the number of occupants is determinable from the number of detected body heat and the security is determinable from the number of detected heartbeats and or body heat.

12. The method of claim 10, wherein the step of determining the number of occupants in the home comprises the step of arranging at least one plurality sensor system in the home to detect at least one of the plurality sections and plurality distribution applied to the each entrance such that the number of occupants is determinable from the at least one of the detected plurality sections and plurality distribution.

13. The method of claim 10, wherein the step of determining the number of occupants in the home comprises the step of arranging at least one body temperature sensor to measure temperature in the various sections whereby the number of occupants is determinable from the measured temperature in the various sections, whereby at least one body temperature is configured with at least one interactive-detector to provide an indication of the interactive-detector being in communication with at another one interactive detector, whereby the number of occupants is determinable from the communicated state of information of the interactive-detectors.

14. The method for enabling security vigilant monitoring and communication comprising
a control server comprising a communication means configured to transmit various detection applications and communicatively connected to a at least an entertainment device comprising at least an interactive television;
said interactive television responsive for viewing contents and said communication means comprising a wireless/wired device configured with method for using in-house communication control device to set a wireless/wired electronic device to join a wireless/wired local area network (LAN);
said communication means further comprising sending a setup request from the control server configured with in-house entertainment devices comprising interactive detection means via at least a limited access connection;
said setup request comprising a request to be compiled on the control server to the wireless/wired LAN for receiving a data package from at least said in-house entertainment device,
said data package including at least a detection by the interactive detection means to enable network data distribution necessary for wireless/wired device to join the wireless LAN for utilizing the network data at the control server to establish a full access connection to an access point of at least a home;
said communication means configured with said interactive detectors in communications with said control server comprising:
at least a modem;
computer means comprising a micro processor, at least one memory means, at least an input/output means configured with at least one input/output;
said communications means connected to the communication control device and configured for selectively and simultaneously transmitting and receiving analog and digital images;
said control server in communication with least wireless/wired communication means;
said communication control device providing at least a wireless/wired interconnectivity of the control server and a wireless/wired network through the communications means in wireless communication with at least a local internet service provider portal to the network, at least a satellite network;
said interactive television comprising at least a media device responsive to normal read-only data, and the computer means having operating software contained on one of the memory means; and
at least a logic means is configured with at least a software configured for in-house positioning and communications.

15. The method of claim 14, wherein the step of determining at least one fire-property or characteristic of occupancy of the homes comprises the step of determining the number of human occupants in the various sections through at least said interactive detection.

16. The method of claim 14, further comprising the steps of:
said interactive detection sensing a state of the home, a state of occupancy of the home, and/or a state of a component of the home;
transmitting the state of the home, the state of occupancy of the home, and/or the state of the component of the home to at least a control server;
sensing a state of the environment around and exterior of the home; and
transmitting information about the environment of the home.

17. The method of claim 16, further comprising the step of determining when the home experiences a break-through, the step of transmitting information about the occupancy of the home comprising the step of transmitting information when it has been determined that the home has experienced a break-through.

18. The method of claim 16, further comprising the steps of:
providing a memory unit in the home television to receive the information about the security and occupancy state of the home and storing the information about the security and occupancy state of the home for transmission to at least a control server; and
interrogating the memory unit to obtain the stored information about the security and occupancy state of the home to enable detection data transmission thereof.

19. The method of claim 16, further comprising the steps of:
monitoring and providing assistance to a home, comprising the steps of:
determining at least one fire-property or characteristic of occupancy of the home constituting information about the security and occupancy state of the home;
determining at least one state of the home or of a component of the home constituting information about the operation of the home;
selectively and automatically establishing a communication channel between the home and a remote facility without manual intervention to thereby enable the information about the security and occupancy state of the home and the information about the operation of the home to be transmitted to the remote facility to enable assistance to be provided to the home based on the transmitted information;
at the remote facility, considering the information about the security and occupancy state of the home and the information about the operation of the home received from the control server, said control server directing assistance to the home based on the transmitted information; and
the step of selectively and establishing a communication channel between the home and a remote facility without manual intervention comprising the step of addressing a transmission of information about the security and occupancy state of the home differently from a transmission of information about the operation of the home.

20. The method of claim 19, further comprising the steps of:
obtaining images of the various sections of the home; and
transmitting the images of the various sections after an emergency and/or a break-through involving the home;
determining when the home experiences a break-through, the step of obtaining images of the various sections of the home comprising the step of obtaining images including the image of an intruder of the home; and
transmitting the images of the various sections just prior to the break-through once it has determined that the home has experienced a break-through.

21. The method of claim 20, wherein the step of determining at least one fire-property or characteristic of occupancy of the home comprises the step of determining any motion in the various sections of the home,
whereby information about any motion of occupants in the various sections is transmitted as part of the information about the security and occupancy state of the home; and,
determining the number of occupants in the various sections, the number of occupants in the various sections being transmitted as part of the information about the security and occupancy state of the home.

22. The method of claim 21, wherein the step of determining the number of occupants in the home comprises the steps of receiving waves or radiation energy from all of the each locations in the various sections of the home and determining the number of occupants in the various sections from the received waves, energy or radiation, and arranging at least one heartbeat sensor and at least a body heat sensor in the various sections of the home to detect the presence of heartbeats and body heat in the home such that the number of occupants is determinable from the number of detected body heat and security is determinable by at least the heartbeats.

23. The method of claim 22, wherein the step of determining the number of occupants in the home comprises the step of arranging at least one plurality sensor in the home to detect at least one of the plurality sections and plurality distribution assigned to each entrance such that the number of occupants is determinable from the at least the presence of home occupant in one of the detected plurality sections and plurality distribution; and
arranging at least one temperature sensor to measure temperature in the various sections whereby the number of occupants is determinable from the measured temperature in the various sections.

24. The method of claim 26, wherein the step of determining the number of occupants in the home comprises the step of arranging at least one interactive-detector to provide an indication of the interactive-detector being in communication with at least another one interactive detector, whereby the number of occupants is determinable from the information provided by the state of the interactive-detectors;
sensing a state of the environment around the interior/exterior of the home;
transmitting information about the environment of the home; to at least the control server;
transmitting information when it has been determined that the home has experienced a break-through;
using a portable device to obtain detection data from the control server; and
receiving said request and processing said request by said control server.
